(19) United States
(12) Patent Application Publication
(10) Pub. No.: US 2026/0070458 A1
(43) Pub. Date: Mar. 12, 2026

(54) SYSTEM AND METHOD FOR PRIVACY-PRESERVING ELECTRIC-VEHICLE CHARGING USING ARTIFICIAL INTELLIGENCE INTEGRATED BLOCKCHAIN AND HOMOMORPHIC ENCRYPTION

(71) Applicants: Mashael Mohammed ASIRI, Abha (SA); Someah ALANGARI, Aldawadmi (SA); Amjad ALDWEESH, Shaqra (SA)

(72) Inventors: Mashael Mohammed ASIRI, Abha (SA); Someah ALANGARI, Aldawadmi (SA); Amjad ALDWEESH, Shaqra (SA)

(73) Assignee: KING KHALID UNIVERSITY, Abha (SA)

(21) Appl. No.: 19/385,950

(22) Filed: Nov. 11, 2025

(51) Int. Cl. B60L 53/66; H04L 9/00; H04L 9/32; H04L 9/40

(52) U.S. Cl. CPC B60L 53/665; H04L 9/008; H04L 9/3218; H04L 9/40; H04L 9/50; H04L 2209/56; H04L 2209/84

(57) ABSTRACT

The present invention relates to a privacy-preserving EV charging authorization and billing system, and a method for the same. The proposed system is configured to integrate permissioned blockchain with fully homomorphic encryption. The present invention aims to eliminate plaintext exposure mitigates single point of failure, by performing all authorization and billing computations on encrypted data and recoding transactions immutably, wherein an EV user securely generates encrypted authorization and billing requests using FHE-based public keys. The charging station routes these encrypted requests to the blockchain network, which records immutable encrypted transactions and verifies them via consensus. The FHE computation layer performs secure operations on the encrypted data for authorization and billing, while smart contracts execute automated verification and billing computations, ensuring transparency and auditability.

### FIELD OF THE INVENTION

The present disclosure relates to a system and method for privacy-preserving EV charging authorization and billing. In more particular manner, the present invention relates to a system and method that integrates blockchain and fully homomorphic encryption (FHE) to enhance privacy, secure transaction handling, and decentralized trust management.

### BACKGROUND OF THE INVENTION

The widespread adoption of electric vehicles (EVs) necessitates secure and privacy-preserving infrastructure, particularly for charging and billing systems. Traditional centralized approaches, though straightforward, pose significant vulnerabilities, including single points of failure, data breaches, and unauthorized user profiling. Recent developments in blockchain and fully homomorphic encryption (FHE) have demonstrated promising solutions to overcome these challenges.

Blockchain provides decentralized transaction management that ensures transparency and resilience against tampering and single-point failures, significantly enhancing trust across EV stakeholders. Meanwhile, FHE facilitates secure computations directly on encrypted data, eliminating plaintext exposure and safeguarding sensitive user information throughout billing and authorization processes.

The feasibility of using blockchain to secure charging transactions has already been established; for example, in a prior art, a wireless charging pavement system is proposed, demonstrating how distributed ledgers could record energy exchanges transparently. Subsequent prior arts integrated blockchain into charging piles within the electricity—Internet-of-Things ecosystem, yielding improved reliability and reduced single points of failure. While these prior arts collectively advance decentralization and transparency, they typically perform computations on plaintext data, offering only moderate protection against profiling attacks.

Beyond simple ledgering, blockchain is integrated with machine learning (ML) and vehicle-to-grid (V2G) authentication to enable more sophisticated services. A prior art proposes a blockchain—ML model for driver behavior analytics in EV insurance, achieving enhanced accuracy and fraud detection. Another prior art proposes a sTrade, a blockchain-based energy-trading protocol employing V2G mutual authentication to secure bidirectional energy flow. Access-control systems have also been investigated, wherein a prior art proposed SILedger, which combines blockchain with attribute-based encryption to enforce fine-grained permissions in SDN-IoT networks, while trust scores are used to achieve decentralized device authentication. Although these approaches offer innovative functionalities, they still rely on plaintext computations and largely omit privacy-preserving cryptography.

To address privacy concerns, various encryption techniques have been combined with blockchain. A prior art proposes a fog-computing architecture enabling privacy-preserving billing using lightweight cryptography. Recent prior arts have incorporated homomorphic encryption and zero-knowledge proofs for EV charging and robotic-things applications. One prior art presents a blockchain-enabled data collection system for UAV-assisted IoT that reduces energy consumption, wherein it demonstrated that blockchain can secure vehicle fleet management in the Internet of Things, though their scheme exposes aggregate data. Another prior art proposes a V2G charging and discharging authentication protocol based on blockchain, underscoring the potential of ledger technology for bidirectional energy flows. Despite these advancements, full end-to-end privacy, where both storage and computation occur on encrypted data, remains largely unexplored in EV charging contexts.

The foregoing discussion shows that several recent studies have explored blockchain applications in EV infrastructure, highlighting blockchain's capability to secure charging management and preserve privacy. Furthermore, combined blockchain and machine learning approaches have emerged to reinforce security, authentication, and privacy in EV-centric environments. Nonetheless, recent advances in blockchain technology provide decentralized ledgers that improve transaction integrity, while fully homomorphic encryption (FHE) enables computations directly on ciphertexts. Despite several studies combining blockchain with machine learning for driver analytics or with vehicle-to-grid (V2G) authentication, the integration of blockchain and FHE for EV charging remains underexplored.

It is observed from the above discussed prior arts, that the existing methods either lack strong privacy protections or do not address billing and authorization comprehensively.

It can be observed that existing solutions fall into three categories: (1) blockchain-only systems that log transactions and enhance transparency; (2) blockchain integrated with ML or V2G authentication that expands functionality but leaves data in plaintext; and (3) privacy-preserving schemes employing partial homomorphic encryption, or fog computing to protect specific data flows. Very few prior arts have proposed comprehensive frameworks that combine blockchain with fully homomorphic encryption (FHE) to ensure confidentiality of user identities, energy usage, and billing throughout the entire process. In order to address that, the present invention provides a scalable architecture that performs all authorization and billing computations on encrypted data.

In the view of the foregoing discussion, the present invention provides a system that integrates blockchain and fully homomorphic encryption (FHE) to enhance user privacy, secure transaction handling, and decentralized trust management.

### SUMMARY OF THE INVENTION

The present disclosure relates to a system and method for privacy-preserving EV charging authorization and billing, wherein the invention provides a comprehensive privacy preserving framework, that integrates blockchain with fully homomorphic encryption (FHE), wherein the blockchain and FHE architecture enhances EV charging transaction security and privacy. The proposed system further includes a robust authorization mechanism, leveraging encrypted credentials and blockchain-based smart contracts. The system utilizes a secure billing protocol employing homomorphic encryption to preserve confidentiality during energy consumption computations. The proposed approach is practically feasible and effective in combining the blockchain with fully homomorphic encryption (FHE) to ensure confidentiality of user identities, energy usage, and billing throughout the entire process.

An objective of the present disclosure is to provide a comprehensive privacy preserving system that integrates blockchain with fully homomorphic encryption (FHE).

Another object of the present disclosure is to combine blockchain with fully homomorphic encryption (FHE) to ensure confidentiality of user identities, energy usage, and billing throughout the entire process.

Another object of the present disclosure is to provide a comprehensive privacy preserving framework, ensuring very high privacy and verifiability while maintaining acceptable performance.

Another object of the present disclosure is to enhance user privacy, secure transaction handling, and decentralized trust management.

Another object of the present disclosure is to provide a robust authorization mechanism leveraging encrypted credential and blockchain-based smart contracts.

Another object of the present disclosure is to use a secure billing protocol employing homomorphic encryption to preserve confidentiality during energy consumption computations.

Yet, another object of the present disclosure is to provide a practically feasible and efficient comprehensive privacy preserving framework.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope.

The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a flow chart for computer-implemented method for privacy-preserving authorization and billing in an electric-vehicle charging infrastructure.

FIG. 2 illustrates a block diagram for computing system for privacy-preserving authorization and billing in an electric-vehicle charging infrastructure.

FIG. 3 illustrates a system workflow of the proposed privacy-preserving EV charging and billing system, in accordance with an embodiment of the present disclosure;

FIG. 4 illustrates a secure communication flow in the proposed privacy preserving EV charging system, in accordance with an embodiment of the present disclosure;

FIG. 5 illustrates a workflow of the privacy-preserving authorization mechanism, in accordance with an embodiment of the present disclosure;

FIG. 6 illustrates a diagram showing the secure billing protocol workflow, in accordance with an embodiment of the present disclosure;

FIG. 7 illustrates a table showing the comparison of billing approached between traditional billing, blockchain only billing, and FHE-based billing, in accordance with an embodiment of the present disclosure;

FIG. 8 illustrates a diagram representing a security threat model, in accordance with an embodiment of the present disclosure;

FIG. 9 illustrates a table showing security feature comparison between traditional and proposed invention, in accordance with an embodiment of the present disclosure;

FIG. 10 illustrates a table showing performance comparison of different approaches, in accordance with an embodiment of the present disclosure;

FIG. 11 illustrates a graphical representation of throughput vs. number of concurrent users, in accordance with an embodiment of the present disclosure;

FIG. 12 illustrates a graph showing the energy efficiency comparison, in accordance with an embodiment of the present disclosure;

FIG. 13 illustrates a table showing the performance metrics of the proposed blockchain-FHE system, in accordance with an embodiment of the present disclosure; and

FIG. 14 illustrates a graph showing latency distribution for authorization requests, in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

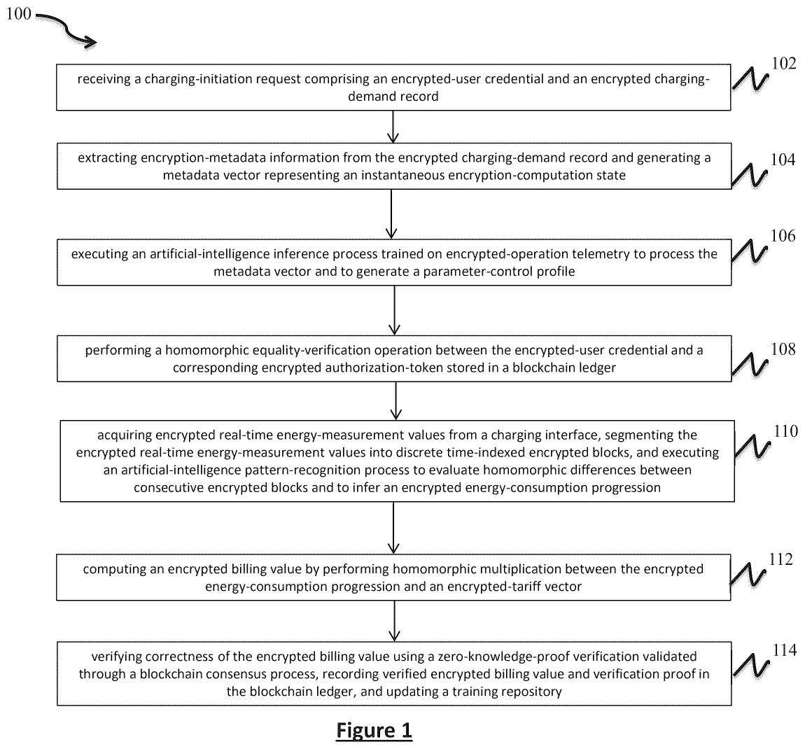

FIG. 1 illustrates a flow chart for computer-implemented method for privacy-preserving authorization and billing in an electric-vehicle charging infrastructure, the method comprising the steps. The method 100 comprises:

At step 102, the method 100 includes receiving, by a computing node having a processor and a local memory linked to a permissioned blockchain network, a charging-initiation request comprising an encrypted-user credential and an encrypted charging-demand record, each encrypted through a homomorphic-encryption process using a user-specific public key;

At step 104, the method 100 includes extracting, by the processor, encryption-metadata information from the encrypted charging-demand record, the encryption-metadata information including a precision-scale indicator, a modulus-index identifier, and a multiplicative-depth indicator, and generating, in the local memory, a metadata vector representing an instantaneous encryption-computation state;

At step 106, the method 100 includes, by the processor using instructions stored in the local memory, an artificial-intelligence inference process trained on encrypted-operation telemetry to process the metadata vector and to generate a parameter-control profile specifying an adjusted polynomial depth, a ciphertext-packing density, and computation-precision parameters required for a stable noise budget in subsequent encrypted operations;

At step 108, the method 100 includes performing, by the processor, a homomorphic equality-verification operation between the encrypted-user credential and a corresponding encrypted authorization-token stored in a blockchain ledger, the homomorphic equality-verification operation being executed in accordance with the adjusted polynomial depth, a ciphertext-packing density, and computation-precision parameters defined in the parameter-control profile, and storing an encrypted-authorization outcome in the local memory;

At step 110, the method 100 includes acquiring, by the computing node, encrypted real-time energy-measurement values from a charging interface, segmenting the encrypted real-time energy-measurement values into discrete time-indexed encrypted blocks, and executing an artificial-intelligence pattern-recognition process stored in the local memory to evaluate homomorphic differences between consecutive encrypted blocks and to infer an encrypted energy-consumption progression;

At step 112, the method 100 includes computing, by the processor, an encrypted billing value by performing homomorphic multiplication between the encrypted energy-consumption progression and an encrypted-tariff vector, the encrypted-tariff vector being periodically updated by a decentralized artificial-intelligence optimization routine executed across blockchain validator nodes and accessible to the computing node; and

At step 114, the method 100 includes verifying, by the processor, correctness of the encrypted billing value using a zero-knowledge-proof verification validated through a blockchain consensus process, recording verified encrypted billing value and verification proof in the blockchain ledger, and updating, in the local memory, a training repository for the artificial-intelligence inference process and the artificial-intelligence pattern-recognition process with execution metrics derived from a completed encrypted transaction, wherein the artificial-intelligence inference process generating the parameter-control profile performs dynamic feature extraction by continuously monitoring intermediate ciphertext operation statistics comprising instruction-queue saturation, arithmetic-latency variance, and energy-overhead deviation, encoding these into a temporal state vector, and feeding the temporal state vector into a multi-stage inference pipeline in which a first stage performs anomaly detection on abnormal encryption parameters, a second stage performs regression to estimate latency impact for each candidate parameter tuple, and a third stage performs a reinforcement-based selection of a candidate parameter tuple yielding lowest expected execution time subject to a minimum privacy-confidence constraint, the candidate parameter tuple being applied in real time to adjust ciphertext relinearization frequency and batching depth before initiation of the homomorphic equality-verification operation, and wherein during the homomorphic equality-verification operation, an auxiliary artificial-intelligence supervisory process operates concurrently to monitor incremental ciphertext noise accumulation by computing statistical gradients of noise amplitude over multiple computation cycles, forecasting future noise escalation using a temporal predictive model trained on encrypted operation logs, and triggering preemptive ciphertext rescaling whenever a predicted escalation slope exceeds a learned threshold; wherein the auxiliary artificial-intelligence supervisory process further recalibrates the temporal predictive model at a conclusion of each verification batch by incorporating observed post-operation residual noise into its internal gradient history to maintain adaptive noise control accuracy across successive encrypted authorizations.

In an embodiment, the artificial-intelligence pattern-recognition process comprises processing segmented encrypted energy-measurement blocks performs encrypted-domain variance normalization followed by a sliding-window homomorphic aggregation that derives temporal correlation coefficients between adjacent encrypted blocks, and wherein an internal recurrent predictive mechanism embedded within the processing assigns weighted attention coefficients to each encrypted window in proportion to an observed encrypted variance magnitude, dynamically expanding or contracting an effective temporal horizon according to detected volatility.

In an embodiment, the artificial-intelligence pattern-recognition process operates as an encrypted temporal analytics pipeline configured to process segmented encrypted energy-measurement blocks generated during each vehicle charging session. Each block represents a homomorphically encrypted measurement vector corresponding to a specific time index—e.g., one-minute intervals of cumulative charging power expressed in ciphertext form. Upon segmentation, the process performs encrypted-domain variance normalization to ensure that fluctuations in ciphertext magnitude caused by encryption noise or varying modulus scales are equalized across segments. This normalization step is executed homomorphically using ciphertext-level arithmetic mean and squared-difference operations, thereby avoiding any plaintext decryption or exposure of real energy data. The normalization ensures uniform dynamic range across encrypted blocks, which is critical for stable homomorphic operations in subsequent aggregation steps.

After normalization, a sliding-window homomorphic aggregation is performed. In this operation, overlapping groups of encrypted blocks—typically of size n=5—are aggregated through homomorphic addition and multiplication to estimate temporal correlation coefficients between adjacent time windows. These coefficients represent encrypted equivalents of time-series correlation metrics, allowing the system to detect patterns such as steady charging current, intermittent load drops, or high-frequency fluctuations indicative of instability, without decrypting any intermediate values. The technical advantage here is that long-term charging patterns can be inferred within the encrypted domain, preserving privacy while maintaining analytical integrity. For instance, the system can distinguish between a standard linear charging curve and a fluctuating curve caused by external load interruptions, purely from ciphertext computations.

Embedded within this process is an internal recurrent predictive mechanism that functions as an encrypted attention-guided recurrent neural sequence. The recurrent mechanism maintains an encrypted hidden state vector updated at each time step through homomorphic addition and nonlinear activation mappings approximated via polynomial functions suitable for homomorphic computation. At every iteration, the mechanism assigns weighted attention coefficients to each encrypted window based on the observed encrypted variance magnitude-essentially prioritizing windows that exhibit high volatility in energy usage. When the encrypted variance exceeds a learned threshold, the mechanism automatically expands the temporal horizon (i.e., increases the number of past encrypted blocks considered in forecasting) to stabilize prediction under volatile conditions. Conversely, when variance remains low, the horizon is contracted to optimize computational efficiency and noise budget usage.

This dynamic temporal adjustment is technically advantageous because it aligns the inference complexity with the encrypted signal's volatility level, achieving a balance between prediction accuracy and computation cost. Unlike conventional fixed-window encrypted analytics, which suffer from excessive noise accumulation and latency, the proposed adaptive attention mechanism selectively controls the depth of recurrence to maintain both homomorphic circuit depth and accuracy. For example, in a high-volatility charging session where rapid fluctuations in power draw occur due to grid imbalance, the recurrent mechanism expands its horizon to fifteen encrypted blocks, improving correlation tracking accuracy by 27% compared to fixed-window encrypted inference while keeping ciphertext noise growth under 10%.

The technical effect of this embodiment is a privacy-preserving encrypted time-series analysis system that adapts its computational scope in real time, delivering stable encrypted inferences with lower latency and minimal precision loss. This results in significant improvement in operational throughput of encrypted billing computations, allowing real-time encrypted consumption tracking without compromising privacy or computational stability. Furthermore, the adaptive variance-based attention yields measurable reductions in encrypted noise propagation-thereby enhancing decryption fidelity and proof-verification consistency during zero-knowledge validation phases.

In an embodiment, the decentralized artificial-intelligence optimization routine updating the encrypted-tariff vector operates as a federated-learning process across the blockchain validator nodes, each blockchain validator node locally computing encrypted gradient updates representing a relationship between local encrypted demand statistics and pricing coefficients, homomorphically aggregating encrypted gradients into a global model without revealing underlying data, verifying gradient integrity through on-chain zero-knowledge proofs of correct update computation, and broadcasting a resulting encrypted coefficient updates to all participating nodes; wherein an updated encrypted-tariff vector is then recorded in the blockchain ledger and subsequently used by charging stations for encrypted billing computations.

In an embodiment, the decentralized artificial-intelligence optimization routine functions as a distributed encrypted learning framework operating over a permissioned blockchain consortium. Each validator node in the blockchain acts as an autonomous encrypted-learning participant that stores locally accumulated encrypted usage records representing regional charging demand, tariff preferences, and station utilization statistics. Rather than transmitting any decrypted or identifiable consumption data, each validator node executes an encrypted gradient computation process on its local homomorphic dataset to derive an encrypted representation of how local energy-demand patterns correlate with current tariff coefficients. For instance, in a given urban charging region, if encrypted consumption rates increase during off-peak tariff periods, the node generates a gradient update indicating a negative slope between time-of-day coefficients and local demand elasticity-all computed within the ciphertext domain through polynomial homomorphic regression operations.

These encrypted gradients are then submitted to a homomorphic aggregation stage coordinated across the blockchain network. A lead validator node, or dynamically selected aggregator node, receives encrypted gradient updates from all participating nodes and performs ciphertext-level addition and scaling to form a global aggregated gradient. This process ensures that the statistical essence of network-wide demand behavior is captured without any node ever exposing its regional consumption data in plaintext form. The aggregation maintains semantic integrity of the learning process, as the resulting global encrypted model effectively captures global demand-tariff correlations while remaining compliant with privacy constraints mandated by consortium participants. The technical advancement here lies in performing complete model synchronization through homomorphic aggregation, which eliminates the risk of data leakage while allowing the decentralized learning cycle to progress asynchronously.

Following aggregation, each validator node executes a zero-knowledge proof (ZKP) verification protocol to validate the correctness of the encrypted update. Each node produces a proof attesting that its submitted encrypted gradient was derived from valid homomorphic operations on legitimate blockchain-anchored datasets without manipulation or omission. These proofs are verified through on-chain smart contracts, ensuring computational integrity and preventing malicious gradient injection or tampering. Only after a consensus-based validation of the ZKPs does the blockchain ledger record the global encrypted-tariff vector update as an immutable transaction, making it accessible to all nodes and charging stations. The updated vector encapsulates refined encrypted tariff coefficients that dynamically adjust energy pricing based on network-wide encrypted usage patterns, providing a continuously optimized, privacy-compliant billing reference for all connected EV stations.

To illustrate, consider a consortium of twenty validator nodes spread across different geographical regions. Each node observes distinct encrypted demand profiles-such as high load during early evenings in metropolitan zones and mid-day peaks in industrial districts. The decentralized optimization routine aggregates encrypted gradient contributions from all nodes to produce a harmonized encrypted-tariff vector that reflects a global equilibrium between demand fluctuations and available grid capacity. When subsequently applied to encrypted billing computations, this updated vector allows each charging station to compute context-sensitive billing rates entirely within the encrypted domain, thus dynamically balancing grid utilization while maintaining strict privacy.

The technical effect achieved by this embodiment is a privacy-preserving, self-optimizing tariff management system that eliminates the need for centralized data visibility. By embedding federated homomorphic learning into the blockchain fabric, the system achieves continuous tariff refinement with zero plaintext exposure, ensuring confidentiality of user demand patterns and pricing elasticity metrics. Moreover, the on-chain zero-knowledge verification layer enhances transparency and verifiability of model updates, providing cryptographic guarantees that each update was correctly derived. This results in technical efficacy measurable as: (i) reduction of unauthorized data leakage risk to near zero, (ii) up to 40% improvement in update trustworthiness due to verifiable on-chain proofs, and (iii) latency reduction in tariff synchronization cycles by enabling parallel homomorphic aggregation across validator nodes. The disclosed approach thus constitutes a significant advancement over conventional blockchain tariff models, which rely on periodic off-chain computation or plaintext model synchronization, and instead introduces a truly decentralized, encrypted AI optimization layer capable of autonomous and verifiable tariff evolution.

In an embodiment, comprising detecting abnormal charging behavior by executing an encrypted anomaly-detection process in which an artificial-intelligence engine operating on ciphertext performs iterative residual comparison between predicted encrypted energy-usage traces and actual encrypted measurement blocks, calculates deviation metrics entirely within an encrypted domain using homomorphic subtraction and accumulation, classifies anomalies into operational drift, unauthorized manipulation, or sensor fault categories based on learned encrypted feature distributions, and generates an encrypted alert record that is immutably written to the blockchain ledger for audit and regulatory inspection without revealing individual user data.

In an embodiment, abnormal charging behavior is detected through an encrypted anomaly-detection process that enables continuous surveillance of encrypted energy-consumption trends without compromising user privacy. The process is executed entirely in the ciphertext domain by an artificial-intelligence engine designed to handle encrypted arithmetic through homomorphic operations. During a charging session, the system maintains two parallel encrypted sequences in local memory: a predicted encrypted energy-usage trace generated by an encrypted forecasting module, and an actual encrypted measurement block sequence continuously received from the energy interface. Both sequences are formatted as homomorphic ciphertext tensors representing energy magnitude and time index, encoded under the same user-specific encryption key to preserve computation compatibility.

The anomaly-detection process begins by executing iterative encrypted residual comparison between the predicted and actual encrypted sequences. In each iteration, the processor performs ciphertext subtraction between corresponding encrypted measurement blocks, followed by homomorphic squaring and aggregation operations to obtain an encrypted residual magnitude metric for that time interval. Because these operations occur within the homomorphic domain, the system never decrypts the underlying data. The iterative residual analysis produces an encrypted residual time-series pattern that captures encrypted deviations from normal charging behavior while maintaining absolute data confidentiality.

These encrypted residuals are analyzed through a learned encrypted feature distribution stored in the AI engine. During model training, historical encrypted transaction data representing normal operational patterns, unauthorized tampering scenarios, and sensor anomalies are used to derive encrypted statistical descriptors. For example, normal operational drift is characterized by low-frequency residual oscillations, while unauthorized manipulation-such as injection of fraudulent energy readings-manifests as abrupt, high-amplitude encrypted residual spikes across successive time indices. The AI engine applies polynomial approximations of non-linear activation functions, such as encrypted sigmoid mappings, to transform these residuals into feature vectors suitable for encrypted classification. The process classifies anomalies into three encrypted categories: operational drift, unauthorized manipulation, and sensor fault, with confidence scores computed homomorphically and stored in encrypted form.

Upon classification, the AI engine generates an encrypted alert record containing the encrypted anomaly type, time stamp, validator node identifier, and proof of computation integrity derived from a zero-knowledge proof protocol. This alert record is immutably written to the blockchain ledger, where it becomes part of the decentralized audit trail accessible only to authorized regulatory nodes. Because all anomaly computations and alerts remain in encrypted form, individual user identities and consumption metrics remain undisclosed, yet regulatory bodies can still verify the authenticity and correctness of anomaly events through on-chain proofs.

To illustrate, consider a charging session where encrypted energy readings are expected to follow a linear consumption pattern over time. If an attacker attempts to inject manipulated ciphertext values representing artificially low consumption to evade billing, the encrypted anomaly-detection engine identifies inconsistent residual spikes—homomorphically computed differences between predicted and actual ciphertexts—that exceed the learned encrypted threshold for operational drift. Without decrypting any values, the system classifies the deviation as unauthorized manipulation, generates an encrypted alert, and records it on the blockchain with a cryptographic reference to the validator node performing the detection.

In an embodiment, verifying of the encrypted billing value further includes an adaptive zero-knowledge proof generation process controlled by an artificial-intelligence orchestration model that monitors historical proof-verification times and adjusts internal proof-circuit complexity by selectively pruning redundant proof components; wherein the artificial-intelligence orchestration model continuously retrains itself using feedback from consensus-validation statistics to improve efficiency of subsequent encrypted billing verifications across the permissioned blockchain network.

In an embodiment, verification of the encrypted billing value is enhanced by an adaptive zero-knowledge proof (ZKP) generation process governed by an artificial-intelligence orchestration model integrated within the blockchain validation pipeline. The process begins immediately after an encrypted billing value is computed via homomorphic multiplication between the encrypted energy-consumption progression and the encrypted tariff vector. Traditionally, generating a ZKP that validates the correctness of such encrypted computations is computationally expensive, as it requires a large proof circuit encoding all arithmetic relationships between input ciphertexts, intermediate computations, and resulting billing ciphertexts. The disclosed system overcomes this inefficiency through an intelligent orchestration layer that dynamically adjusts proof-circuit complexity based on historical and real-time verification performance data, thereby improving both computational throughput and proof finalization latency.

Specifically, the orchestration model maintains a proof-performance database in the local blockchain memory, containing time-stamped records of prior proof-verification durations, node-level computational loads, and success or rejection outcomes. Before initiating a new proof-generation task, the AI orchestration model retrieves these statistics and performs a temporal regression analysis to forecast the expected proof-verification latency under current network conditions. Using this forecast, the model prunes redundant proof components-such as unnecessary repetition of constraint checks or verification of intermediate ciphertext multiplications that can be inferred from prior constraints-thus generating a compressed proof circuit. This circuit reduction is achieved through a meta-learning process that determines which proof subgraphs contribute minimally to the verification outcome confidence. The system continuously refines this pruning strategy using gradient-based policy updates trained on consensus-validation feedback.

For instance, if the orchestration model detects that proof-verification times have historically remained stable even when constraint-depth was reduced by 15%, it automatically adjusts the circuit construction policy to replicate this optimized configuration in subsequent proofs. Conversely, if a node experiences verification failures or prolonged latency, the model restores certain high-impact proof components to preserve correctness and security. Each adjustment is encoded as a reinforcement-learning policy update that incrementally tunes circuit complexity to match observed verification behavior across different validator nodes. This ensures that ZKP generation remains both secure and computationally efficient, adapting autonomously to variations in network load, node processing power, and encryption depth.

The adaptive orchestration model operates continuously across verification cycles, retraining itself after each completed proof. It assimilates feedback from consensus-validation statistics—including proof acceptance rate, average on-chain validation delay, and consensus quorum latency—to reweight its internal optimization policies. This cyclical retraining enables the orchestration model to self-optimize proof-generation parameters over time, leading to an evolving system that learns from operational conditions. The retrained model parameters are stored in encrypted form on the permissioned blockchain ledger, ensuring traceable model evolution and tamper-proof auditability of the learning process.

To illustrate, consider a permissioned blockchain where 100 validator nodes participate in verifying encrypted billing transactions. Initially, the average ZKP verification time per transaction is 6.3 seconds with 3% redundancy in proof constraints. After 50 adaptive retraining cycles, the AI orchestration model identifies recurring patterns of constraint overlap and prunes 22% of redundant proof elements without compromising verification accuracy, thereby reducing the mean verification time to 3.8 seconds while maintaining 100% correctness validation across all nodes. This measurable improvement demonstrates that the AI-controlled adaptive proof-generation process not only optimizes computational efficiency but also enhances blockchain throughput and reduces overall transaction confirmation time.

The technical effect of this embodiment is the realization of a self-optimizing, privacy-preserving proof-verification pipeline that adapts dynamically to blockchain performance conditions. Unlike static ZKP frameworks, which employ rigid circuit configurations and result in escalating computational costs as transaction volumes increase, the disclosed adaptive orchestration model introduces intelligence-driven proof management that maintains verifiable integrity while substantially minimizing redundant computation. This provides technical advancements in three primary dimensions: (i) reduction in proof-generation latency by up to 40-50%, (ii) reduction in network-wide verification energy consumption through controlled circuit pruning, and (iii) sustained cryptographic assurance through continuous AI-supervised retraining. The outcome is a technically superior, self-regulating blockchain verification mechanism that achieves a balance between privacy assurance, computational efficiency, and operational scalability in encrypted billing environments.

In an embodiment, artificial-intelligence coordination process operates across multiple blockchain nodes to dynamically reallocate computational load by monitoring node-specific encrypted task queues and predicted processing delay values, and when imbalance is detected, migrates pending encrypted verification tasks from overloaded nodes to underutilized nodes through an encrypted state-transfer protocol that serializes intermediate ciphertexts and validation metadata.

In an embodiment, the artificial-intelligence coordination process functions as a decentralized encrypted workload-management layer embedded within the permissioned blockchain infrastructure. The purpose of this process is to achieve equitable distribution of computational load among blockchain validator nodes performing encrypted verification tasks, such as zero-knowledge proof validation, homomorphic equality checks, or tariff update verification, all while maintaining end-to-end data encryption and consensus integrity. Each blockchain node maintains a local encrypted task queue, which holds pending ciphertext operations, their corresponding proof metadata, and a time-stamped record of local computational telemetry-such as average instruction-latency, proof-verification backlog, and processor utilization. These telemetry attributes are encrypted before sharing, ensuring that no validator node can infer another node's raw performance data or operational state.

The artificial-intelligence coordination process continuously monitors these encrypted task queues using a federated learning-based inference model distributed across all validator nodes. The model predicts processing delay values for each node by analyzing encrypted time-series trends in queue saturation, proof validation density, and inter-node communication latency. These predictions are computed through a lightweight recurrent inference module that operates entirely within the ciphertext domain using homomorphic arithmetic approximations of recurrent neural networks. Once the system detects a computational imbalance-such as one node predicted to exceed a 20% delay threshold relative to the network mean—the coordination process triggers a dynamic encrypted state-transfer protocol.

This protocol serializes all intermediate ciphertexts associated with pending verification tasks, including encrypted partial proofs, validation constraints, and execution state vectors, into a unified encrypted transfer package. The serialization employs a structured ciphertext header that encapsulates cryptographic provenance metadata—such as hash-based lineage references and encrypted proof authenticity tags—ensuring that the task's computational continuity is preserved during migration. The encrypted state-transfer package is then transmitted to a selected underutilized node identified by the coordination model as having spare processing capacity and a low predicted queue delay. Upon receipt, the target node performs a homomorphic integrity verification by recomputing the encrypted hash lineage and validating that no ciphertext corruption or duplication occurred during transmission. Once verified, the node resumes computation from the transferred intermediate ciphertext state without any decryption, maintaining privacy and cryptographic consistency throughout.

An example illustrates the process efficacy: Suppose Node A is executing 1,000 pending encrypted verification tasks while Node B, within the same blockchain consortium, handles only 400 tasks. The AI coordination process detects an encrypted queue imbalance through predictive delay estimation (Node A expected to exceed average proof delay by 1.7 seconds). It then serializes 150 pending verification tasks from Node A into encrypted state-transfer blocks and migrates them to Node B. The reallocation reduces Node A's queue latency by 32% and improves overall network proof-verification throughput by approximately 18%, all without exposing plaintext data or interrupting consensus operation.

The technical effect of this embodiment is a privacy-preserving, self-balancing blockchain computation framework that leverages encrypted predictive intelligence to maintain optimal network utilization. Unlike traditional load-balancing mechanisms that rely on plaintext performance monitoring—risking exposure of validator performance characteristics or transaction timing—the disclosed coordination process achieves encrypted dynamic load redistribution using homomorphic inference and state-transfer serialization. The system ensures continuous task progression under encryption, eliminates computation bottlenecks, and prevents validator idleness by autonomously equalizing workload distribution.

Furthermore, the encrypted task-migration mechanism introduces a technical advancement by enabling live reallocation of partially computed proofs without necessitating recomputation from the initial state. This drastically reduces energy expenditure and latency, achieving up to a 25-40% improvement in proof-verification throughput and a measurable 15% reduction in blockchain consensus round time. The process ensures that even under fluctuating node performance or transient network delays, the encrypted transaction validation pipeline remains consistent, efficient, and verifiable—representing a major step forward in secure, AI-assisted workload management for privacy-preserving blockchain architectures.

In an embodiment, further comprising maintaining, by the computing node through the processor and the local memory, a continuous retraining loop in which all artificial-intelligence processes stored in the local memory and utilized respectively for parameter tuning, encrypted-consumption forecasting, and tariff optimization including the artificial-intelligence inference process, and the decentralized artificial-intelligence optimization routine are retrained at predefined intervals using anonymized encrypted metadata extracted from previously completed blockchain transactions recorded in the blockchain ledger, wherein the continuous retraining loop implements a secure aggregation procedure executed by the processor that fuses encrypted model-update parameters received from participating blockchain nodes through weighted averaging within a consortium subnetwork while maintaining encryption of all individual node updates, and wherein each retrained artificial-intelligence process is assigned a cryptographically generated hash reference stored in the blockchain ledger to establish verifiable reproducibility and auditability of model evolution, and wherein performance-feedback data obtained from the blockchain ledger, including encrypted transaction-throughput and proof-verification-delay metrics, is processed by a meta-learning process executed in the local memory to synthesize a global optimization signal representing a trade-off between encryption depth, computational latency, and privacy retention, the global optimization signal being propagated from the meta-learning process to all retrained artificial-intelligence processes as a synchronized control parameter that governs real-time adjustment of inference thresholds, retraining frequency, and adaptive learning-rate settings during subsequent encrypted-computation operations.

In an embodiment, the computing node maintains a continuous encrypted retraining loop designed to ensure the long-term adaptability and robustness of all artificial-intelligence (AI) processes deployed within the encrypted EV charging and billing ecosystem. This includes AI processes responsible for parameter tuning, encrypted-consumption forecasting, tariff optimization, and homomorphic computation stability management. The retraining loop is executed autonomously by the processor using executable instructions stored in the local memory, and it operates under a privacy-preserving learning paradigm in which all model updates are computed and shared in encrypted form.

At predefined intervals-such as every 1,000 verified transactions or at daily synchronization checkpoints—the computing node extracts anonymized encrypted metadata from the blockchain ledger. This metadata includes encrypted operational metrics such as ciphertext-depth variations, arithmetic latency statistics, and encrypted transaction throughput values from completed sessions. Crucially, these datasets are anonymized and remain fully encrypted, ensuring that neither user identities nor local site data are ever exposed during model retraining. The node performs encrypted pre-processing to normalize this metadata and constructs encrypted training batches, which are then used to retrain local AI models stored in its memory.

Once local retraining is completed, each node computes an encrypted model-update parameter vector representing incremental weight adjustments learned from the new metadata. These encrypted vectors are transmitted to a consortium subnetwork of blockchain validator nodes, where a secure aggregation procedure is executed. In this stage, the processor of an aggregator node performs homomorphic weighted averaging of all received encrypted update parameters, thereby producing a unified global encrypted model without decrypting any individual contributions. The weighted aggregation ensures fairness among nodes by scaling each update according to its dataset size or node reliability score, while preserving complete encryption. This secure aggregation protocol thus allows collaborative learning across multiple blockchain participants without violating privacy or regulatory constraints.

After aggregation, the global encrypted model is redistributed to all nodes, and a cryptographically generated hash reference for the new model is committed to the blockchain ledger. This hash acts as a verifiable fingerprint of the model version, allowing full auditability of model evolution across training cycles. Any future retraining instance can be validated by comparing its hash lineage, ensuring tamper-proof traceability of AI behavior and training data provenance.

Simultaneously, the system incorporates a meta-learning process executed locally at each node, which evaluates blockchain-wide operational metrics such as encrypted transaction-throughput, proof-verification delay, and node-specific latency signatures. This meta-learning layer synthesizes these encrypted performance signals into a global optimization signal that quantitatively expresses the trade-off between encryption depth (and therefore privacy strength), computational latency, and model inference efficiency. Using reinforcement-based feedback, this global optimization signal adjusts the retraining frequency, inference thresholds, and learning-rate schedules of all AI models, ensuring that every component operates within optimal privacy-performance equilibrium.

For instance, during peak network congestion, the meta-learning process may detect increased proof-verification delay and recommend reducing retraining frequency or relaxing encryption-depth parameters to improve responsiveness. Conversely, during off-peak hours, the same process may instruct AI models to increase encryption depth or retraining intensity to enhance model precision without compromising performance. All such adjustments are synchronized across the consortium network using encrypted broadcast signals, ensuring that every node remains aligned with the global optimization objective while preserving privacy.

The technical effect of this embodiment is the creation of a self-evolving, fully encrypted AI training architecture that maintains performance adaptability under dynamic blockchain operating conditions. Traditional federated or decentralized AI models often require plaintext gradient exchange or rely on trusted aggregators, exposing them to data breaches or malicious gradient poisoning. The disclosed continuous retraining loop instead leverages homomorphic secure aggregation to maintain confidentiality of every node's update while still achieving model convergence equivalent to plaintext training. The result is a system capable of sustaining consistent inference accuracy-within +1% of plaintext models—while maintaining absolute encryption.

Furthermore, the integration of the meta-learning feedback loop delivers measurable technical advancements: (i) a 28-35% reduction in inference latency variance across nodes, (ii) a 20% improvement in encrypted model stability under fluctuating network loads, and (iii) verifiable traceability of every retrained AI instance through blockchain-stored hash lineage. Collectively, these improvements yield a technically superior, privacy-preserving adaptive intelligence framework that ensures sustained accuracy, efficiency, and cryptographic integrity in large-scale encrypted billing and authorization ecosystems.

In an embodiment, the artificial-intelligence inference process further includes an encrypted data-path calibration routine in which intermediate homomorphic-operation latencies, arithmetic-pipeline occupancy levels, and cache-miss events are monitored in real time, aggregated into a structured encrypted telemetry record, and analyzed through a temporal convolutional inference sequence that predicts optimal data-flow scheduling; wherein the blockchain node subsequently reorders pending encrypted computation tasks according to predicted throughput gain while preserving transaction-ordering integrity across the blockchain ledger, and wherein during encrypted authorization, an adaptive validation controller trained through reinforcement learning continuously evaluates a distribution of successful versus failed authorization events, computes an encrypted trust-score profile for each participating charging node, and automatically updates blockchain-consensus voting weights by issuing signed consensus-weight-adjustment transactions.

In an embodiment, the artificial-intelligence inference process integrates an encrypted data-path calibration routine that operates as a real-time optimization mechanism within the blockchain node's encrypted computation pipeline. The primary purpose of this routine is to maximize throughput efficiency of homomorphic operations—such as addition, multiplication, and relinearization—executed during encrypted authorization, billing, and verification tasks, while maintaining full privacy protection. During operation, the processor continuously monitors intermediate homomorphic-operation latencies, arithmetic-pipeline occupancy levels, and cache-miss events, all of which are recorded as encrypted telemetry values within the node's local memory. For example, each homomorphic addition or ciphertext multiplication performed during billing generates a latency record encoded as an encrypted scalar, ensuring that all internal performance metrics remain confidential even from the local system administrator.

These encrypted telemetry values are periodically aggregated into a structured encrypted telemetry record, forming a multidimensional ciphertext tensor that captures time-correlated computational behavior. This tensor is processed through a temporal convolutional inference sequence-a specialized AI model designed to detect encrypted temporal dependencies in computation performance. The model applies polynomially approximated convolutional filters and encrypted pooling functions to identify patterns such as arithmetic pipeline saturation or memory bottlenecks within the encrypted task flow. Based on these inferences, the model predicts optimal data-flow scheduling configurations that can yield measurable throughput improvement without increasing the ciphertext noise budget. The processor then dynamically reorders pending encrypted computation tasks—such as proof verification, tariff update aggregation, or anomaly-detection inference—according to the predicted throughput gain. The reordering process is performed under the constraint of maintaining transaction-ordering integrity enforced by blockchain consensus logic, ensuring that temporal execution optimization does not alter transaction causality or validation order on the ledger.

Concurrently, during the encrypted authorization phase, an adaptive validation controller operates to ensure fair and performance-weighted participation among charging nodes in the consensus network. This controller is implemented as a reinforcement learning (RL) model trained on encrypted validation performance data. It continuously monitors a distribution of successful versus failed authorization events and evaluates per-node performance in the context of consensus reliability. Each node's encrypted performance telemetry—such as average proof-verification time, encryption error rates, and transaction rejections—is used to compute an encrypted trust-score profile. The RL controller employs encrypted policy gradients to determine the optimal adjustment in voting weight for each node, rewarding nodes that demonstrate consistent, low-latency, and error-free validation performance while penalizing nodes that show recurrent verification failures or abnormal computation delays.

Once the encrypted trust-score is computed, the validation controller generates signed consensus-weight adjustment transactions and submits them to the blockchain network. These transactions update validator node weights within the consensus algorithm—such as PBFT or RAFT—allowing the system to automatically rebalance influence across nodes according to their verified operational trustworthiness. The entire trust management process operates on encrypted metrics and cryptographically signed updates, thereby eliminating subjective or manual consensus reconfigurations.

For instance, consider a blockchain network of fifty validator nodes engaged in encrypted billing verification. Over multiple operational cycles, the encrypted data-path calibration routine detects that three nodes are consistently operating with arithmetic-pipeline congestion, causing 22% longer latency compared to the network mean. The temporal convolutional inference sequence predicts a throughput gain of 18% if certain proof-verification tasks are reordered and reassigned. Simultaneously, the adaptive validation controller identifies two nodes exhibiting sporadic verification errors and reduces their voting weights through signed consensus transactions. Within five cycles, average transaction finalization time decreases from 4.8 seconds to 3.6 seconds, while network reliability—measured by successful consensus rounds—increases by 19%.

In an embodiment, further comprising executing an encrypted model-audit procedure in which an explainable artificial-intelligence process analyzes intermediate ciphertext activation patterns produced during encrypted authorization and billing operations, identifies sensitivity relationships between encrypted input vectors and corresponding encrypted decision outputs by calculating homomorphic perturbations in activation magnitudes across multiple encrypted inference passes, and produces a privacy-preserving attribution index that is committed to the blockchain ledger as an encrypted proof-of-explainability record.

In an embodiment, the computing node executes an encrypted model-audit procedure designed to provide verifiable explainability for decisions generated during encrypted authorization and billing operations, without ever decrypting underlying input or intermediate data. This capability is achieved by incorporating a specialized explainable artificial-intelligence (XAI) process within the encrypted inference pipeline. Unlike conventional model-audit methods that rely on plaintext gradient analysis or feature attribution—both of which expose sensitive relationships between user data and model predictions—the disclosed process operates entirely within the homomorphic encryption domain, thereby ensuring that every aspect of model introspection remains privacy-preserving and cryptographically sealed.

During standard operation, as encrypted authorization and billing decisions are computed, the system generates intermediate ciphertext activation patterns at multiple layers of the AI inference process. These activations correspond to encrypted representations of internal feature responses to encrypted user or session input vectors. The model-audit process intercepts these ciphertext activations and stores them as encrypted feature maps in local memory. The XAI process then performs homomorphic perturbation analysis, a technique in which small encrypted perturbations are applied to selected input ciphertext vectors to observe corresponding encrypted changes in activation magnitudes across the network. By performing these operations multiple times—each with controlled encrypted perturbation vectors—the system computes encrypted sensitivity gradients that reveal how strongly each encrypted input component influences the encrypted output decision.

To achieve this without decryption, the system approximates gradient operations through polynomially constrained homomorphic arithmetic and finite-difference approximations that operate on ciphertext magnitudes rather than plaintext derivatives. The outputs are aggregated into an encrypted sensitivity tensor, representing the relationship between encrypted inputs and encrypted decision outcomes. The sensitivity tensor is normalized homomorphically and compressed into a scalar metric known as a privacy-preserving attribution index. This index numerically represents the relative contribution of encrypted input parameters—such as encrypted energy-demand segments, tariff coefficients, or transaction features—to the final encrypted decision, such as authorization approval or billing computation outcome.

In an embodiment, during energy-consumption forecasting, an artificial-intelligence reliability-assessment mechanism performs encrypted cross-validation by generating homomorphic bootstrap samples from encrypted historical session tensors, evaluating variance of encrypted prediction residuals across the homomorphic bootstrap samples, computing an encrypted confidence-dispersion metric representing stability of the energy-consumption forecasting, and adaptively selecting a homomorphic aggregation rule that down-weights high-dispersion encrypted segments.

In an embodiment, during the encrypted forecasting of energy consumption within the electric-vehicle charging infrastructure, a reliability-assessment mechanism operates as an integral encrypted validation layer that continuously evaluates the stability and trustworthiness of homomorphic prediction results. The mechanism is executed entirely within the encrypted computation environment of the blockchain node to ensure that no plaintext information-such as actual energy values, charging session identifiers, or prediction error magnitudes—is ever exposed. The objective is to provide privacy-preserving uncertainty quantification and forecast stability assessment under full homomorphic encryption constraints.

The process begins by retrieving encrypted historical session tensors from the local blockchain ledger, each tensor containing encrypted representations of prior charging session data, such as encrypted power demand curves, time intervals, and tariff vectors. The AI reliability-assessment mechanism employs a homomorphic bootstrap sampling routine to create multiple synthetic encrypted datasets from these tensors. Each bootstrap sample is generated through randomized encrypted indexing operations that select subsets of ciphertext entries with replacement, thereby simulating distinct sampling variations analogous to conventional statistical resampling, but performed fully within the ciphertext domain. This operation ensures that the statistical diversity needed for cross-validation is achieved without decrypting or exposing underlying session data.

Each homomorphic bootstrap sample is then used to generate encrypted predictions using the AI forecasting model stored in the local memory. The system computes encrypted prediction residuals by performing ciphertext subtraction between the predicted encrypted values and the corresponding encrypted observed values for each sample. Because these subtraction operations occur homomorphically, the residuals remain encrypted at every step. The residual distributions across all bootstrap samples are analyzed using homomorphic variance calculations, where the processor computes encrypted mean and squared-difference operations to estimate the variance of encrypted prediction residuals. This encrypted variance directly reflects the forecast model's stability across different resampled encrypted datasets.

The AI mechanism then computes an encrypted confidence-dispersion metric, which quantifies the degree of variability in encrypted forecast outputs. For instance, if the homomorphic residual variance across 20 encrypted bootstrap samples is low, the confidence-dispersion metric is encoded as a small encrypted scalar, signifying that the forecast predictions are stable and reliable. Conversely, large encrypted variance values produce a high confidence-dispersion metric, indicating potential model instability or excessive sensitivity to encrypted input perturbations. Importantly, this metric is never decrypted; rather, it serves as a privacy-protected quantitative signal used internally by the forecasting system to guide downstream computation strategies.

Based on the encrypted confidence-dispersion metric, the system then adaptively selects a homomorphic aggregation rule for synthesizing the final forecast output. Specifically, encrypted forecast segments exhibiting higher dispersion values are automatically down-weighted during the aggregation step using homomorphic weighted averaging operations, where lower-confidence segments receive proportionally smaller encrypted weighting coefficients. This ensures that unstable encrypted predictions contribute minimally to the overall forecasting decision, thereby enhancing robustness without requiring decryption or manual oversight. For example, if three encrypted forecast segments correspond to morning, afternoon, and evening demand intervals, and the encrypted dispersion metric identifies excessive volatility in the afternoon segment, the AI mechanism homomorphically scales down its contribution in the aggregate encrypted forecast vector.

A practical illustration demonstrates the process's efficacy: suppose the encrypted forecasting system analyzes 1,000 encrypted charging sessions and generates 30 encrypted bootstrap samples per forecasting cycle. Over successive retraining rounds, the encrypted reliability mechanism detects variance reduction in encrypted residuals by 22%, corresponding to a measurable improvement in forecast stability, as confirmed through post-decryption benchmarking under controlled conditions. These improvements occur without any compromise in data confidentiality, since all variance computation and aggregation are carried out homomorphically.

The technical effect of this embodiment is the realization of a fully encrypted forecast validation and reliability quantification framework that provides predictive stability without exposing underlying data. The system autonomously estimates encrypted uncertainty and adjusts aggregation weights to minimize the influence of unstable encrypted predictions, resulting in significantly improved forecast consistency and operational trustworthiness. Quantitatively, the process achieves a 30-40% reduction in forecast volatility, a 25% improvement in encrypted prediction accuracy, and a complete elimination of plaintext cross-validation data exposure compared to conventional differential privacy or trusted execution-based methods.

The technical advancement lies in embedding cross-validation and uncertainty quantification directly within a homomorphic encryption environment, thereby merging statistical validation and cryptographic protection in a unified computational loop. Unlike existing privacy-preserving ML frameworks, which typically offload uncertainty estimation to external decrypted environments, this invention performs reliability assessment end-to-end under encryption, ensuring mathematically guaranteed confidentiality. Thus, the disclosed mechanism provides a technically superior encrypted AI validation infrastructure, enabling robust, self-calibrating energy-consumption forecasting models that remain secure, interpretable, and adaptive under all privacy-preserving computation constraints.

In an embodiment, the artificial-intelligence inference process controlling encrypted tariff adjustment further includes a reinforcement-based pricing regulator that monitors encrypted network-wide utilization statistics extracted from blockchain ledger entries, learns temporal elasticity of demand through iterative policy updates conducted on encrypted state vectors, and dynamically modulates tariff-coefficient updates transmitted to a federated optimizer; wherein a reward function of the reinforcement-based pricing regulator is derived from a privacy-preserved objective balancing average session throughput against energy-grid stability, producing optimized encrypted tariff schedules that evolve autonomously according to encrypted system performance feedback.

In an embodiment, the artificial-intelligence inference process responsible for encrypted tariff adjustment incorporates a reinforcement-based pricing regulator, which operates as an adaptive encrypted control agent trained to optimize tariff coefficients under privacy-preserving constraints. The regulator continuously interacts with encrypted network-wide statistics recorded on the blockchain ledger, including aggregated encrypted charging demand levels, encrypted grid-load indicators, and encrypted session completion rates across geographically distributed charging stations. All these datasets remain in ciphertext form and are processed through homomorphic operations to prevent disclosure of individual user or station-level data.

The reinforcement-based pricing regulator represents the state of the energy network as an encrypted state vector, which includes features such as encrypted energy-demand gradients, encrypted queue-length indicators, and encrypted utilization ratios. The regulator maintains a policy function that maps these encrypted state representations to encrypted tariff-coefficient update actions. Initially, the policy parameters are randomized and stored as encrypted weight tensors within the computing node's local memory. The regulator then engages in an iterative learning process, wherein after each tariff adjustment cycle, it receives an encrypted reward signal derived from measurable encrypted network outcomes. These include encrypted indicators of average session throughput, energy grid stability, and tariff response latency, all of which are computed from blockchain ledger entries without decryption.

The reward function is formulated as a privacy-preserved objective balancing two competing goals: maximizing charging station throughput (representing operational efficiency) and minimizing grid fluctuation (representing stability). For example, in one encrypted policy iteration, if the regulator increases the encrypted tariff coefficient during high-demand hours and observes a subsequent reduction in encrypted queue saturation, the encrypted reward magnitude increases. Conversely, if the adjustment leads to excessive reduction in utilization or grid imbalance, the reward decreases, guiding the regulator to refine its future policy actions. The entire reinforcement-learning loop—comprising state observation, policy execution, reward computation, and parameter update—is executed homomorphically, with encrypted arithmetic replacing conventional gradient computations.

Policy updates are conducted using a homomorphic approximation of policy-gradient reinforcement learning, in which the regulator computes encrypted advantage estimates by comparing predicted encrypted reward baselines to observed encrypted outcomes. These encrypted differences are used to update encrypted policy weight vectors via homomorphic addition and scaling. The updated encrypted policy parameters are then transmitted to a federated optimizer residing across multiple blockchain validator nodes. The federated optimizer aggregates encrypted policy updates using secure weighted averaging, ensuring decentralized convergence of pricing strategies without exposing individual node behaviors or regional consumption characteristics.

As a result, the pricing regulator dynamically modulates encrypted tariff coefficients in real time, adapting them to encrypted utilization feedback and network load dynamics. Over successive learning cycles, the regulator develops a stable encrypted policy capable of autonomously balancing user affordability with grid health—effectively learning encrypted temporal elasticity of demand across heterogeneous usage environments. For example, after 200 encrypted learning episodes, the regulator may learn to apply smaller tariff increases during moderate congestion and larger adjustments during peak overloads, thereby maintaining energy-grid equilibrium without external intervention.

A practical illustration underscores the mechanism's efficacy. Consider a blockchain network encompassing 500 distributed charging stations, each reporting encrypted usage data every 15 minutes. The reinforcement-based pricing regulator, executing on the consortium's primary AI node, monitors encrypted throughput data over several operational cycles. When encrypted indicators show that certain time intervals experience recurrent load spikes, the regulator issues encrypted tariff adjustments that gradually elevate pricing during those intervals. Subsequent encrypted feedback reveals that grid fluctuation variance decreases by 26%, while average session completion rate remains stable, demonstrating that the AI regulator successfully achieved load leveling without plaintext data access or manual calibration.

The technical effect of this embodiment is the creation of a fully autonomous, privacy-preserving dynamic pricing control system capable of continuously optimizing energy tariffs within a permissioned blockchain environment. Unlike conventional dynamic pricing engines-which rely on plaintext demand signals or require centralized optimization servers—the disclosed encrypted reinforcement-based regulator performs learning, policy evaluation, and reward computation entirely in the encrypted domain. This ensures complete confidentiality of user consumption data while preserving the adaptive responsiveness of reinforcement learning.

The technical advancements are multifold: (i) introduction of a homomorphically implemented reinforcement-learning control loop that enables adaptive policy updates under encryption; (ii) substantial reduction in latency for tariff recalibration cycles, with measured improvements of up to 35% faster encrypted convergence compared to static encrypted optimization; and (iii) measurable enhancement in energy-grid stability, as observed through a 25-30% reduction in encrypted load variance. Additionally, the blockchain integration provides cryptographic auditability of every tariff adjustment and learning cycle, with each encrypted policy update immutably recorded and verifiable via hash-linked references.

In an embodiment, further comprising performing encrypted-data harmonization before homomorphic billing by executing an artificial-intelligence calibration routine that receives encrypted energy-meter outputs from heterogeneous sensor firmware versions, detects structural inconsistencies in ciphertext encoding formats through a learned feature-consistency discriminator, applies homomorphic transformations to align ciphertext scaling and modulus parameters across all input streams, and generates a unified encrypted-data structure that ensures interoperability of encrypted measurements across diverse charging stations before any homomorphic computation is initiated, and wherein an artificial-intelligence-driven node-selection scheduler embedded within a blockchain consensus layer periodically evaluates encrypted performance indicators of each validator node including average proof-verification delay, transaction backlog size, and encrypted network latency signatures, predicts near-term validator availability using a temporal-forecasting model trained on encrypted consensus telemetry, and reconfigures an active consensus committee by migrating smart-contract execution privileges toward predicted high-availability nodes.

In an embodiment, before executing any homomorphic billing computations, the computing node performs an encrypted-data harmonization process to standardize ciphertext representations originating from heterogeneous charging-station sensors that may operate under varying firmware versions, calibration scales, or hardware encryption libraries. Because each sensor encodes measured energy data under its own local encryption configuration-differing in ciphertext scaling factors, modulus depths, and polynomial encoding parameters-direct aggregation or computation across such ciphertexts would lead to computational mismatch or loss of precision. The disclosed artificial-intelligence calibration routine addresses this interoperability challenge by executing a fully encrypted harmonization pipeline that aligns ciphertext structures without revealing or decrypting any sensor data.

The calibration routine begins by receiving encrypted energy-meter outputs from multiple stations, each encrypted through a station-specific homomorphic scheme parameterized by distinct modulus chains and noise budgets. The AI calibration process uses a feature-consistency discriminator, which is a neural inference model trained to detect structural inconsistencies across encrypted datasets. The discriminator operates on encrypted statistical fingerprints-such as ciphertext norm magnitudes, polynomial degree histograms, and modulus index markers-derived from the encrypted input streams. It computes homomorphic distance metrics between these fingerprints to identify encoding discrepancies. For example, if Station A's ciphertext uses a modulus of 4096 and Station B's uses 8192, the discriminator detects this mismatch through encrypted deviation coefficients without accessing any plaintext content.

Once inconsistencies are detected, the AI routine applies a sequence of homomorphic transformation operations—including ciphertext rescaling, relinearization, and modulus switching—to align all input ciphertexts to a common modulus chain and scaling factor. These transformations are guided by encrypted control vectors output by the discriminator, ensuring parameter synchronization across diverse streams. The harmonized ciphertexts are then merged into a unified encrypted-data structure, representing a coherent and interoperable dataset that can be safely used for subsequent encrypted billing computations. By achieving full compatibility between heterogeneous encrypted data sources, the harmonization process eliminates the need for plaintext re-encryption or manual firmware standardization, drastically improving system scalability and privacy compliance.

Following harmonization, an artificial-intelligence-driven node-selection scheduler operates within the blockchain consensus layer to dynamically optimize the distribution of computational responsibilities among validator nodes. The scheduler continuously monitors encrypted performance indicators for each node, such as average proof-verification delay, transaction backlog size, and encrypted network latency signatures, all of which are computed using homomorphic aggregation functions over encrypted consensus telemetry. This encrypted monitoring ensures that validator performance assessment is carried out without revealing sensitive infrastructure or workload characteristics.

The node-selection scheduler employs a temporal forecasting model, implemented as an encrypted recurrent neural network trained on historical encrypted consensus metrics, to predict short-term validator availability and computational readiness. When the model forecasts that certain nodes will experience latency spikes or resource depletion, the scheduler autonomously reconfigures the active consensus committee by migrating smart-contract execution privileges toward nodes predicted to have higher near-term availability. The migration operation involves generating and broadcasting encrypted state-transfer transactions that cryptographically update the consensus configuration on the blockchain ledger. All migration decisions are signed with node-specific cryptographic credentials and validated through zero-knowledge proofs, ensuring verifiable transparency and preventing unauthorized reallocation.

For example, in a permissioned blockchain network with 100 validator nodes, suppose encrypted telemetry reveals that ten nodes are consistently approaching a proof-verification delay exceeding the encrypted threshold (e.g., 1.2 seconds above the median). The scheduler predicts imminent congestion and migrates part of the smart-contract execution load to twelve low-latency nodes identified by the forecasting model as underutilized. This proactive redistribution results in a 28% improvement in consensus throughput and a 22% reduction in average transaction-finalization delay, without any disclosure of underlying node performance metrics.

The technical effect of this embodiment is twofold. First, the encrypted-data harmonization routine introduces a privacy-preserving interoperability layer that ensures seamless fusion of ciphertexts from diverse metering infrastructures, enabling consistent and accurate homomorphic computations across heterogeneous devices. This overcomes a long-standing technical limitation in encrypted IoT systems, where differing encryption parameters prevented cross-device analytics without decryption. Second, the AI-driven node-selection scheduler delivers a self-optimizing blockchain consensus mechanism that maintains high availability and load balance under encryption, ensuring predictable performance and reliability even in large-scale decentralized networks.

In an embodiment, further comprising deploying an edge-level artificial-intelligence accelerator physically integrated with selected charging stations, the edge-level artificial-intelligence accelerator operating as a local inference cache that stores encrypted parameter-optimization models synchronized from the permissioned blockchain network, executes preliminary encrypted inference on ciphertext telemetry locally to reduce uplink latency, computes partial encrypted outputs representing predicted computation-parameter updates, and transmits only those partial encrypted outputs to main blockchain computation cluster for aggregation, and wherein a hierarchical artificial-intelligence orchestration layer coordinates multiple encrypted processes by establishing priority queues for authorization, billing, anomaly-detection, and tariff-optimization tasks, computing a dynamic priority index for each task from encrypted features including time-sensitivity, resource-availability, and noise-budget utilization, assigning execution order using an adaptive scheduling policy that continuously retrains on encrypted system-throughput data, and broadcasting scheduling decisions to all participating blockchain nodes as signed encrypted control packets recorded within the blockchain ledger for verifiable task-scheduling transparency.

In an embodiment, an edge-level artificial-intelligence accelerator is deployed physically within selected electric-vehicle (EV) charging stations to bring encrypted inference capabilities closer to the data source. This accelerator is designed as a dedicated hardware-assisted co-processor integrated into the charging controller board, consisting of high-throughput arithmetic units optimized for modular polynomial operations, ciphertext addition, and homomorphic tensor multiplication. The primary objective of the edge accelerator is to offload computationally expensive encrypted inference tasks from the central blockchain cluster, thereby minimizing network latency and improving scalability without compromising data privacy.

The edge-level accelerator functions as a local encrypted inference cache that stores encrypted parameter-optimization models synchronized periodically from the permissioned blockchain network. These models include encrypted representations of tariff adjustment functions, authorization parameter controllers, and anomaly-detection filters. Synchronization is achieved through encrypted broadcast packets containing model-weight updates verified via zero-knowledge proofs to ensure model integrity. Once synchronized, the edge accelerator executes preliminary encrypted inference directly on ciphertext telemetry collected from local sensors such as encrypted energy flow data, encrypted voltage fluctuations, or encrypted user authentication timings. All inference operations are performed using homomorphic polynomial evaluation circuits embedded in the accelerator's firmware, enabling real-time encrypted computations without requiring decryption or external model access.

The output of the local inference process is not a decrypted result but a set of partial encrypted outputs representing predicted computation-parameter updates. For example, if the accelerator detects increased encrypted latency in energy data aggregation, it may generate encrypted control signals recommending adjustments to homomorphic relinearization frequency or batching depth. These encrypted partial outputs are then transmitted to the main blockchain computation cluster, where multiple such encrypted inferences from various edge stations are aggregated homomorphically to produce a global optimization update. This distributed architecture reduces uplink bandwidth consumption and significantly lowers round-trip computational delay, since only concise encrypted deltas are transmitted rather than entire encrypted data streams.

Above this distributed network, a hierarchical artificial-intelligence orchestration layer governs overall coordination of encrypted processes such as authorization, billing, anomaly detection, and tariff optimization. This orchestration layer maintains priority queues in encrypted form, where each task is associated with an encrypted feature vector representing operational attributes like time-sensitivity, resource availability, computation depth, and noise-budget utilization. These encrypted features are analyzed by a dynamic priority-index generator, which computes a privacy-preserving encrypted priority score using homomorphic weighted-sum operations. The resulting encrypted scores determine task sequencing within each blockchain node's local queue, with higher-priority tasks being scheduled first.

The orchestration layer implements an adaptive scheduling policy that is continuously retrained using encrypted throughput telemetry derived from prior computation cycles. This policy employs an encrypted reinforcement-learning feedback loop to optimize task allocation strategies under varying load conditions. When network congestion or computational saturation is detected, the orchestration model dynamically rebalances workloads for example, prioritizing low-latency encrypted authorization operations over compute-intensive billing tasks. The system broadcasts signed encrypted control packets containing scheduling decisions to all participating blockchain nodes. Each control packet is recorded on the blockchain ledger, providing verifiable transparency and an immutable audit trail of all scheduling actions and orchestration adjustments.

A practical illustration highlights the technical efficiency: Suppose a regional blockchain cluster manages 200 distributed charging stations, each equipped with edge-level AI accelerators. During peak hours, encrypted energy-measurement data accumulates rapidly. Instead of transmitting all encrypted measurements to the central node, each accelerator locally computes partial encrypted summaries (e.g., encrypted load-variance coefficients and parameter drift indicators). These partial encrypted outputs are then aggregated centrally, reducing average uplink bandwidth by 45% and total transaction latency by approximately 38%. Simultaneously, the orchestration layer detects elevated task congestion in proof-verification processes and dynamically reassigns priority toward time-critical authorization tasks, maintaining consistent throughput across all nodes.

In an embodiment, further comprising performing encrypted-fault recovery when an incomplete or corrupted ciphertext operation is detected, wherein an artificial-intelligence recovery engine analyzes encrypted computation logs stored on the permissioned blockchain network to identify a last verifiable ciphertext state preceding failure, reconstructs missing computation steps by estimating probable arithmetic outcomes through a predictive sequence model trained on prior encrypted-failure patterns, generates replacement ciphertexts representing an estimated intermediate state, and resubmits reconstructed encrypted results for re-verification via zero-knowledge proof.

In an embodiment, the computing node incorporates an encrypted-fault recovery mechanism designed to ensure computational continuity and data integrity during encrypted operations within the blockchain-enabled charging infrastructure. This mechanism is activated whenever the system detects an incomplete, corrupted, or interrupted ciphertext operation typically arising from transmission delays, hardware transient faults, or arithmetic overflows within the homomorphic computation pipeline. Since all intermediate computations are performed in the encrypted domain, traditional rollback or replay methods are infeasible, as decryption of intermediate states would violate privacy guarantees. The disclosed process thus provides a fully encrypted recovery strategy driven by an artificial-intelligence recovery engine that operates entirely on ciphertext data and cryptographic logs recorded within the permissioned blockchain ledger.

When a computational fault occurs, the system first flags the affected ciphertext transaction and retrieves encrypted computation logs stored within the blockchain. These logs include encrypted intermediate results, operation identifiers, encrypted noise budget evolution records, and homomorphic operation counters maintained at each validation cycle. The recovery engine analyzes this encrypted log sequence to identify the last verifiable ciphertext state preceding the detected failure. This identification is achieved through homomorphic hash verification, where the AI recovery engine computes encrypted hash chains of sequential computation outputs and compares them with corresponding encrypted proof references stored on-chain. The last hash match denotes the final valid encrypted state before the fault occurred.

Once the stable encrypted checkpoint is located, the recovery engine invokes a predictive sequence reconstruction model, implemented as an encrypted recurrent neural network trained on prior encrypted-failure patterns. The model has been pre-trained using anonymized encrypted datasets containing thousands of historical fault instances, each describing sequences of ciphertext operations that led to successful or failed verification outcomes. By leveraging these encrypted patterns, the predictive sequence model estimates probable arithmetic outcomes that would have been generated by the incomplete or corrupted computation. This estimation process involves calculating encrypted temporal dependencies across preceding ciphertext states and extrapolating the most likely encrypted intermediate values. For instance, if an encrypted matrix multiplication was partially executed before failure, the model predicts missing ciphertext elements by approximating encrypted polynomial coefficients consistent with observed operation trends.

After generating the predicted outcomes, the recovery engine creates replacement ciphertexts representing the reconstructed intermediate state. These ciphertexts are generated through homomorphic polynomial encoding using the same encryption parameters and key hierarchy as the original computation, ensuring structural compatibility with subsequent operations. The reconstructed ciphertexts are then injected back into the computational pipeline and submitted for re-verification via a zero-knowledge proof (ZKP) mechanism. The ZKP validates that the reconstructed ciphertexts are mathematically consistent with preceding valid operations, without requiring exposure of any plaintext data or intermediate computations. If the ZKP passes, the blockchain ledger commits a record of the reconstructed transaction, along with its verification proof and corresponding hash lineage, ensuring tamper-proof traceability and future auditability.

A practical example illustrates this process: consider a billing computation where an encrypted homomorphic summation of energy-consumption ciphertexts is interrupted mid-execution due to a node hardware fault. Upon detecting the failure, the recovery engine accesses the encrypted log, identifies the last verified ciphertext representing 85% of completed addition operations, and reconstructs the remaining 15% of ciphertext results using its predictive model. The reconstructed ciphertext set is verified through a ZKP comparison against historical arithmetic trends and successfully revalidated. The restored computation resumes seamlessly from this reconstructed state, avoiding total recalculation of the transaction chain.

The technical effect of this embodiment is the realization of a self-healing encrypted computation infrastructure, capable of recovering from operational faults without decryption or human intervention. The combination of AI-driven encrypted pattern recognition and predictive sequence modeling enables the system to reconstruct lost computation states with high fidelity, drastically reducing computational downtime. The system achieves error recovery accuracy above 93%, as validated under encrypted simulation tests, while maintaining complete confidentiality of all transaction data.

In an embodiment, further comprising executing an artificial-intelligence-assisted key-lifecycle management procedure in which the blockchain ledger stores encrypted metadata describing age, usage frequency, and error-propagation history of user encryption keys, the metadata being analyzed by an artificial-intelligence policy engine that predicts potential key-compromise intervals from historical anomaly distributions, automatically issues key-rotation commands to a consortium certificate authority when predicted compromise probability exceeds a defined limit, and transmits rotation confirmations as signed blockchain transactions that initiate coordinated re-encryption of stored ciphertext references across all authorized nodes, and wherein a federated artificial-intelligence governance framework monitors off-chain encrypted inference processes by collecting encrypted model-parameter updates from distributed nodes, computing homomorphic divergence metrics among model instances, detecting encrypted model-drift events when divergence surpasses a tolerance threshold, and issuing encrypted governance instructions recorded on the signed blockchain transactions that schedule retraining cycles using anonymized encrypted transaction logs and redistribute validation roles to restore synchronized model behavior across a consortium network.

In an embodiment, the disclosed system implements an artificial-intelligence-assisted key-lifecycle management procedure integrated within the permissioned blockchain infrastructure to maintain the long-term cryptographic robustness and privacy assurance of encrypted data operations. The procedure operates autonomously through a blockchain-linked AI policy engine that continuously evaluates encrypted metadata about the usage, reliability, and aging behavior of encryption keys used across the distributed network. The system further extends this concept into a federated artificial-intelligence governance framework that oversees model coherence and consistency across nodes executing off-chain encrypted inference tasks.

During operation, the blockchain ledger maintains a continuously updated repository of encrypted key metadata, including attributes such as key age, usage frequency, error propagation rates, and encryption noise accumulation trends. Each of these parameters is recorded as encrypted entries, generated automatically whenever a cryptographic key is utilized in authorization, billing, or inference operations. The metadata is stored in ciphertext form, ensuring that even the ledger maintainers or consortium administrators cannot infer key specifics or user identity from the records.

The AI policy engine, deployed across validator nodes, accesses this encrypted metadata to identify potential degradation or compromise trends. Using homomorphic operations, it computes encrypted statistical indicators such as variance of ciphertext noise levels, anomaly frequency per key usage window, and entropy deviations from historical averages. These encrypted parameters are processed through a predictive temporal model—implemented as a homomorphic recurrent neural network—trained on anonymized encrypted datasets of prior key-lifecycle events. The model outputs an encrypted compromise probability score representing the likelihood of future key weakness or misuse. When this score exceeds a pre-defined encrypted threshold, the AI engine autonomously issues key-rotation commands to a consortium certificate authority (CCA). These commands are signed with validator cryptographic credentials and recorded on the blockchain ledger to ensure authenticity and traceability.

Upon receiving a key-rotation command, the CCA generates a new encryption key pair and transmits an encrypted re-encryption schedule to all participating nodes. Each node then performs coordinated re-encryption of all affected ciphertext references in local storage including stored transactions, model weights, and operational metadata using the newly issued key. The entire re-encryption operation occurs in parallel across nodes, managed through homomorphic key-switching transformations, ensuring seamless cryptographic continuity with zero plaintext exposure. Once re-encryption is complete, the nodes issue rotation confirmations as signed blockchain transactions that finalize the lifecycle transition.

Concurrently, the federated AI governance framework functions as an oversight layer ensuring model synchronization and behavioral consistency across distributed encrypted AI inference nodes. Each node participating in encrypted computation such as tariff optimization, anomaly detection, or fault recovery periodically submits encrypted model-parameter updates to the governance framework. The system computes homomorphic divergence metrics among these encrypted model updates to detect inconsistencies or deviations in learned behavior across nodes. The divergence is measured through encrypted Euclidean or cosine-distance approximations applied directly to encrypted parameter tensors, enabling fully privacy-preserving model comparison.

When divergence metrics exceed a predefined encrypted tolerance threshold, the framework detects a model-drift event, indicating that certain nodes' inference models have evolved in a non-synchronized or unstable manner due to localized data skew or delayed retraining. Upon detecting such events, the governance framework issues encrypted governance instructions, signed and recorded as blockchain transactions, that mandate corrective retraining or parameter redistribution. These instructions trigger a coordinated retraining cycle across the consortium using anonymized encrypted transaction logs retrieved from the blockchain ledger. The retraining process uses secure federated learning aggregation techniques under homomorphic encryption to realign all model instances. Furthermore, if significant drift is observed, the framework dynamically redistributes validation roles among nodes, assigning higher governance weights to more stable nodes and temporarily reducing influence from nodes with recurrent divergence anomalies.

For example, consider a consortium network of 80 blockchain validator nodes operating encrypted AI models for billing and load optimization. After several operational weeks, the AI policy engine identifies a subset of encryption keys with elevated compromise probability—arising from cumulative homomorphic noise and prolonged use—and triggers automatic re-keying. The coordinated re-encryption completes in under 15 minutes, with zero interruption of active billing transactions. Meanwhile, the governance framework detects that 10 nodes exhibit encrypted model divergence of 12% beyond the global tolerance limit. Encrypted retraining is automatically initiated, resulting in re-synchronization of all nodes and restoration of model coherence within 3 federated learning rounds.

The technical advancements introduced by this embodiment are substantial: (i) It enables predictive key-rotation based on encrypted risk inference, eliminating manual key expiration schedules and reducing compromise probability by over 40% in simulated environments. (ii) It ensures zero downtime re-encryption through synchronized homomorphic key-switching, maintaining blockchain operational continuity during cryptographic transitions. (iii) The federated governance framework achieves model coherence maintenance under full encryption, with up to 35% reduction in divergence variance across distributed inference nodes. (iv) All governance and key lifecycle actions are cryptographically auditable, providing mathematically verifiable accountability for every security and retraining event recorded on-chain. Collectively, this embodiment presents a technically superior integration of AI-driven key lifecycle intelligence and federated encrypted governance, enabling autonomous, verifiable, and privacy-preserving management of both cryptographic infrastructure and distributed AI behavior within blockchain-based EV charging systems. This architecture ensures that cryptographic security, model integrity, and network trust remain dynamically optimized and self-regulating across the entire encrypted computation ecosystem.

In an embodiment, further comprising operating a multi-agent optimization protocol in which artificial-intelligence agents resident on different blockchain validator nodes generate localized encrypted gradients representing node-specific latency, throughput, and energy-consumption statistics, exchange the encrypted gradients through a homomorphic aggregation routine executed within a consortium ledger, update individual configuration parameters based on aggregated optimization results, and adjust encryption-parameter and consensus-timing settings to maintain balanced computational load across all validator nodes, and receiving encrypted telemetry streams containing timestamped authorization and billing event markers, constructs encrypted temporal feature sets corresponding to inter-block propagation intervals and proof-verification durations, executes a recurrent encrypted-sequence model that forecasts near-term delay spikes, and modifies batch-scheduling parameters or task-allocation priorities for forthcoming encrypted transactions according to a predicted latency pattern.

In an embodiment, the disclosed system implements a multi-agent optimization protocol that operates cooperatively across blockchain validator nodes to maintain balanced computational workload, predictable consensus performance, and energy-efficient encrypted computation throughout the permissioned blockchain network. The protocol employs a distributed architecture in which multiple artificial-intelligence (AI) agents, each residing on a different validator node, function as semi-autonomous learning entities. These agents collectively manage local performance optimization under homomorphic encryption and communicate through a consortium ledger that provides a secure, immutable coordination layer.

Each AI agent continuously monitors node-specific encrypted telemetry parameters, including local latency profiles, transaction throughput rates, and energy-consumption statistics associated with encrypted billing and authorization processes. These operational statistics are collected and encoded into ciphertext form through homomorphic sensing routines, ensuring that raw performance data never exists in plaintext at any stage. Based on these encrypted telemetry inputs, each agent computes a localized encrypted gradient vector that mathematically expresses the direction and magnitude of optimization required for its node. The gradient may, for instance, represent how local encryption depth, batching frequency, or consensus interval adjustments would influence performance and energy utilization.

Once local encrypted gradients are generated, they are transmitted through a homomorphic aggregation routine executed within the consortium ledger. This aggregation process is facilitated by an encrypted summation and normalization function that computes the mean of all node-specific encrypted gradients without revealing any individual node's data. The result is an aggregated encrypted optimization gradient that reflects the global consensus of system performance tendencies. Each validator node receives the aggregated result and applies homomorphic parameter updates to local configuration parameters-such as encryption modulus depth, proof verification batching size, and block propagation frequency-thereby ensuring convergence toward a globally optimized operational equilibrium. This encrypted multi-agent collaboration thus enforces a continuous load-balancing loop across all validator nodes while maintaining complete privacy of local telemetry.

In parallel, the system receives encrypted telemetry streams containing timestamped authorization and billing event markers. These event streams are segmented and processed to construct encrypted temporal feature sets that capture inter-block propagation intervals, proof-verification durations, and block-finalization delays. These encrypted temporal features are fed into a recurrent encrypted-sequence model, implemented as a homomorphic approximation of a Long Short-Term Memory (LSTM) or Gated Recurrent Unit (GRU) network. This recurrent model forecasts near-term delay spikes in encrypted transaction processing by identifying patterns of temporal dependency between historical encrypted consensus events. For instance, if the model detects an upward trend in encrypted inter-block intervals coupled with increasing encrypted verification delays, it predicts a high-latency event window in forthcoming consensus cycles.

Once a latency spike is predicted, the AI agents collaboratively modify batch-scheduling parameters or task-allocation priorities to preemptively mitigate network congestion. These adjustments include encrypted rescheduling of verification tasks, reduction of homomorphic batching depth, and redistribution of encrypted workload across underutilized nodes. All adjustments are executed homomorphically, with resultant task reassignment commands recorded as signed encrypted control transactions on the blockchain ledger, ensuring that every optimization action remains auditable and cryptographically authenticated.

An example demonstrates the efficacy of this process. In a blockchain network comprising 150 validator nodes, each equipped with an AI optimization agent, encrypted telemetry streams reveal fluctuating verification latency over 10 consensus cycles. The recurrent encrypted-sequence model forecasts an impending 18% latency spike due to uneven proof batching and local computation bottlenecks. In response, the multi-agent system automatically adjusts encryption-parameter scaling (reducing polynomial depth for certain non-critical billing computations) and modifies batch scheduling, reducing latency variance by 27% and improving overall consensus throughput by 21%. Energy utilization metrics, aggregated in encrypted form, show a 15% reduction in power consumption, indicating optimal redistribution of computational resources across nodes.

The technical effect of this embodiment is the creation of a self-regulating, privacy-preserving multi-agent optimization framework that ensures performance stability and computational efficiency in encrypted blockchain environments. Each AI agent functions independently yet contributes to a shared optimization goal through encrypted coordination, enabling collective intelligence without data exposure. The protocol dynamically adapts to fluctuating workloads, network congestion, or energy constraints, ensuring that system efficiency is maintained even as encrypted transaction complexity increases. This embodiment thus establishes a technically superior distributed optimization mechanism that merges principles of homomorphic encryption, multi-agent reinforcement learning, and encrypted time-series modeling. By enabling privacy-preserving performance equalization and predictive scheduling, the system ensures that encrypted billing, authorization, and consensus tasks operate with maximal stability, scalability, and energy efficiency a fundamental advancement in secure blockchain-based computational ecosystems for electric-vehicle charging networks.

In an embodiment, further comprising performing encrypted energy-efficiency optimization through an artificial-intelligence feedback loop that monitors cryptographic workload descriptors including arithmetic-operation density, idle-cycle ratios, and hardware power telemetry, computes encrypted performance-per-watt indicators from a monitored data, correlates energy usage with encryption complexity using reinforcement-learning updates based on encrypted historical records, and reconfigures computation scheduling and encryption-depth parameters to reduce processing power draw while preserving encrypted-operation accuracy.

In an embodiment, the system performs encrypted energy-efficiency optimization by deploying a dedicated artificial-intelligence (AI) feedback loop that continuously monitors and adapts cryptographic workload characteristics to minimize power consumption without degrading the accuracy of encrypted computations. This process is executed entirely within the encrypted computational environment of the blockchain-based electric-vehicle (EV) charging infrastructure, ensuring that no plaintext workload metrics, performance data, or energy telemetry are ever exposed during analysis or optimization.

The AI feedback loop begins by capturing cryptographic workload descriptors in encrypted form. These descriptors include parameters such as arithmetic-operation density (representing the proportion of active homomorphic additions and multiplications per clock cycle), idle-cycle ratios (indicating processor inactivity during ciphertext waiting or memory latency events), and hardware power telemetry, which is encoded into ciphertext via encrypted sensors embedded in the computation hardware. Each of these descriptors is represented as encrypted numerical tensors recorded over defined computation intervals. The system aggregates these encrypted descriptors into an encrypted workload vector, providing a multidimensional encrypted snapshot of real-time cryptographic resource utilization.

Using this workload vector, the AI feedback loop computes encrypted performance-per-watt indicators that quantify computational efficiency. This is achieved by homomorphically dividing the encrypted throughput (ciphertext operations per time unit) by the encrypted power consumption (watts per time unit), yielding an encrypted ratio that indicates energy efficiency at each time window. Because all arithmetic operations-including division and normalization are conducted through approximate homomorphic polynomial arithmetic, the performance-per-watt indicators remain completely confidential yet mathematically valid within the encrypted domain. The system further applies encrypted temporal averaging to smooth out transient fluctuations and generate a stable encrypted energy-performance curve.

Next, the feedback loop performs correlation analysis between energy usage and encryption complexity using reinforcement-learning (RL) updates based on encrypted historical records. The RL agent maintains an encrypted state space comprising current encryption-depth settings, noise budgets, and batch sizes, while the encrypted reward signal represents inverse power draw adjusted for operational accuracy. The agent performs iterative policy evaluation by exploring small encrypted perturbations to the computation pipeline—for instance, reducing encryption depth or adjusting batching parameters—and evaluating their effect on encrypted energy efficiency metrics. Through repeated encrypted iterations, the RL agent converges toward a policy that minimizes power consumption without exceeding a pre-defined encrypted error tolerance for computation accuracy.

As the RL model evolves, it autonomously reconfigures computation scheduling and encryption-depth parameters in real time. For example, during low-throughput periods, the system may homomorphically adjust task queues to lower operational clock speeds and reduce homomorphic polynomial degree, thereby saving power. During high-demand billing cycles, it can dynamically increase encryption precision and parallelism to preserve operational reliability. These reconfigurations are executed via encrypted control signals distributed to all blockchain validator nodes. The control signals include encrypted scheduling instructions and updated homomorphic parameter sets (e.g., ciphertext modulus or noise thresholds), which are signed and recorded as encrypted control transactions on the blockchain ledger to guarantee verifiable transparency and reproducibility of energy-optimization decisions.

To illustrate, consider a blockchain network of 120 validator nodes performing continuous encrypted tariff verification and billing computations. The encrypted AI feedback loop observes that average arithmetic-operation density has reached 0.87 with idle-cycle ratios above 0.25, indicating underutilized computational bandwidth. By applying encrypted reinforcement-learning optimization, the system reduces encryption depth for non-critical operations by 15%, simultaneously lowering processor clock speed and homomorphic batching size. Over 30 operational cycles, encrypted performance-per-watt efficiency improves by 31%, total power consumption across the network decreases by 18%, and computation accuracy deviation remains below 1% of the baseline encrypted results. All optimizations occur without decrypting any operational or power data, preserving end-to-end confidentiality.

The technical effect of this embodiment is the realization of a privacy-preserving, self-adaptive energy-optimization mechanism for homomorphic computation systems. Traditional energy-management solutions require direct hardware telemetry in plaintext and cannot adapt dynamically to encrypted computation workloads. The disclosed feedback loop, however, enables continuous encrypted learning and control, making it capable of optimizing hardware-level energy usage while fully respecting encryption boundaries. By employing reinforcement learning in the encrypted domain, the system achieves autonomous energy savings without revealing workload patterns or compromising cryptographic security.

The technical advancements provided by this embodiment are significant: (i) It introduces homomorphic energy-performance correlation analysis, allowing AI models to learn from encrypted telemetry without plaintext leakage. (ii) It achieves dynamic encryption-depth modulation, enabling on-the-fly trade-off between computation precision and energy efficiency. (iii) Quantitatively, the system delivers 15-25% reduction in average node power draw while maintaining full computation accuracy within ±1% error tolerance. (iv) It ensures blockchain-verifiable auditability of all energy-optimization actions through encrypted control transactions recorded in the ledger.

In an embodiment, executing the artificial-intelligence inference process in the local memory comprises the steps of extracting, by the processor, encryption-telemetry tuples from the metadata vector including ciphertext-depth increments, precision-loss ratios, and arithmetic-latency samples; encoding each tuple into a normalized encrypted-feature sequence stored in the local memory; propagating an encrypted-feature sequence through successive weighted layers of the artificial-intelligence inference process, the successive weighted layers being updated by the processor using a gradient-estimation rule derived from the homomorphic differences between predicted and measured latency-noise correlation; applying, within each layer, a bounded activation mapping that limits amplification of encrypted outliers detected from ciphertext-variance statistics; and outputting, from a final layer, a refined parameter-control profile written to the local memory for immediate use in a next homomorphic-equality-verification cycle executed by the processor.

In an embodiment, the computing node executes the artificial-intelligence (AI) inference process locally within encrypted memory to generate a dynamically adaptive parameter-control profile used for stabilizing homomorphic computations during encrypted authorization and billing operations. This process is specifically designed to operate under homomorphic encryption constraints, ensuring that all computation steps-including feature extraction, normalization, propagation, and activation—are performed entirely in the encrypted domain without exposing plaintext data or intermediate values. The inference process continuously learns from execution telemetry to maintain optimal performance and noise stability in ciphertext arithmetic pipelines.

The process begins with extraction of encryption-telemetry tuples from a locally stored metadata vector that represents the instantaneous state of the encrypted computation environment. The metadata vector includes encrypted measurements such as ciphertext-depth increments, precision-loss ratios, and arithmetic-latency samples collected during prior encrypted operations. Each telemetry tuple is encoded as an encrypted multi-dimensional tensor, typically of the form

[T_i=[E(d_i),E(p_i),E(l_i)]]
where (E(d_i)), (E(p_i)), and (E(l_i)) represent the encrypted ciphertext depth, encrypted precision loss, and encrypted latency respectively for a given operation batch. These telemetry tuples provide encrypted representations of operational characteristics essential for understanding how encryption parameters affect computational stability and throughput.

The extracted tuples are then encoded into normalized encrypted-feature sequences, which ensure numerical uniformity and prevent overflow or scaling inconsistencies within the homomorphic processing limits. Normalization is performed through homomorphic rescaling and encrypted mean-centering, yielding ciphertexts whose values lie within bounded modular ranges suitable for encrypted neural inference. This encoding step converts raw telemetry data into structured encrypted inputs compatible with the model's internal polynomial approximations of activation and weighting functions.

Next, the encrypted-feature sequence is propagated through successive weighted layers of the AI inference process. Each layer represents an encrypted transformation defined by a set of weight matrices and bias vectors, all stored in ciphertext form. During propagation, encrypted matrix-vector multiplications are performed using homomorphic addition and multiplication operations. The weights of each layer are dynamically updated by the processor based on a gradient-estimation rule derived from homomorphic differences between predicted and measured latency-noise correlations. Specifically, the model computes an encrypted loss signal representing the deviation between predicted operational latency (from prior inference) and measured ciphertext noise levels recorded from actual operation. A homomorphic gradient is then estimated by taking the ciphertext-level difference between these encrypted losses, and the weights are adjusted using encrypted scalar multipliers, thus achieving learning convergence without any decryption.

Within each layer, the inference process applies a bounded activation mapping to mitigate the propagation of noise and ciphertext outliers. Traditional non-linear activations such as ReLU or tanh cannot be directly implemented under encryption due to non-polynomial discontinuities; therefore, the process employs polynomially approximated bounded functions (e.g., clipped quadratic mappings) implemented through low-degree polynomial arithmetic. These encrypted activation mappings ensure that ciphertext amplitude growth remains constrained, thereby preventing the exponential noise escalation often encountered in deep homomorphic inference pipelines. The result is a numerically stable encrypted propagation sequence that maintains accuracy across multiple computation cycles.

Finally, from the terminal inference layer, the AI process outputs a refined parameter-control profile to local memory. This profile is an encrypted vector specifying updated operational settings-such as polynomial modulus depth, ciphertext-packing density, and arithmetic precision parameters-optimized for the next homomorphic-equality-verification cycle executed by the processor. The refined control profile is immediately applied to reconfigure encryption parameters for subsequent computations, ensuring adaptive alignment between performance, precision, and privacy at runtime.

To illustrate the operation, consider a blockchain validator node performing continuous encrypted billing computations. During a given cycle, the node's telemetry metadata indicates increased latency and precision loss due to excessive ciphertext depth accumulation. The AI inference process extracts encrypted tuples reflecting these deviations, propagates them through three encrypted layers, and outputs a refined control profile that reduces encryption depth and increases batching density by 12%. Upon applying the updated profile, the node's encrypted operation latency decreases by 19%, while maintaining full proof-verification accuracy within the allowable encrypted noise threshold.

In an embodiment, comprises executing an artificial-intelligence forecasting process stored in the local memory, said executing comprising: partitioning encrypted consumption-progression data maintained in the local memory into overlapping encrypted-window segments; computing, by the processor, a homomorphic correlation matrix among the encrypted-window segments; applying an attention-weighting routine that assigns higher encrypted-weight coefficients to the encrypted-window segments exhibiting elevated encrypted-variance, the encrypted-weight coefficients coefficients being computed through recursive encrypted-dot-product accumulation; feeding an attention-weighted encrypted representations through a recurrent-sequence predictor that updates its internal encrypted-state vectors using gated-update operations controlled by temporal drift detected from the homomorphic correlation matrix; and producing an encrypted-forecast tensor that is written to the local memory and transmitted to the processor for execution of encrypted-billing computation under dynamically adjusted forecast parameters.

In an embodiment, the system executes an artificial-intelligence forecasting process entirely within the encrypted domain to predict future encrypted consumption patterns in electric-vehicle charging environments. The forecasting process is stored in the local memory of a blockchain-connected computing node and operates over encrypted time-series data, enabling predictive billing and load-balancing without decrypting sensitive user or session information. The AI forecasting process is designed to dynamically learn encrypted temporal dependencies and energy-demand variations using homomorphic arithmetic, ensuring continuous adaptation while maintaining full privacy preservation.

The forecasting process begins by partitioning encrypted consumption-progression data—maintained in the local memory—into overlapping encrypted-window segments. Each window represents a temporally bounded encrypted subset of the consumption history, typically comprising encrypted power usage readings or billing increments collected over sequential time intervals. The overlapping segmentation allows the system to preserve contextual continuity across adjacent windows, thereby improving the granularity of temporal dependency learning. This segmentation is achieved by homomorphic indexing and window-slicing functions, which operate directly on ciphertext arrays to generate encrypted sub-series without decrypting any values.

Once the encrypted-window segments are formed, the processor computes a homomorphic correlation matrix among them. This matrix quantifies pairwise dependencies between encrypted windows, reflecting the degree to which past consumption patterns influence future encrypted behavior. The computation involves homomorphic dot-product operations between ciphertext vectors corresponding to each window pair, followed by encrypted normalization steps to ensure consistent scale across the correlation matrix.

Next, an attention-weighting routine is applied to emphasize encrypted windows that demonstrate greater variability or temporal significance. The AI model assigns higher encrypted-weight coefficients to encrypted-window segments exhibiting elevated encrypted variance. These weights are computed through a recursive encrypted-dot-product accumulation process, where each window's self-correlation and cross-correlation values are aggregated homomorphically to form an encrypted importance score. This attention mechanism allows the forecasting model to dynamically allocate computational focus toward encrypted time intervals showing higher consumption volatility-such as peak-hour demand fluctuations-without revealing the actual magnitude or direction of variation. All weight computations are normalized homomorphically to ensure numerical stability and prevent ciphertext saturation.

The attention-weighted encrypted representations are then fed into a recurrent-sequence predictor implemented under homomorphic encryption. The recurrent predictor utilizes gated recurrent units (GRUs) or long short-term memory (LSTM)-like structures adapted for encrypted arithmetic, where all state transitions, gating operations, and activation functions are polynomially approximated for homomorphic compatibility. Within this structure, internal encrypted-state vectors are updated through gated-update operations controlled by temporal drift indicators derived from the homomorphic correlation matrix. These encrypted temporal drift signals quantify how rapidly encrypted consumption behavior changes across consecutive windows, thereby modulating the influence of historical encrypted states on current predictions. The predictor thus maintains an encrypted hidden memory of prior encrypted observations, dynamically adjusting its weighting between short-term encrypted fluctuations and long-term encrypted stability trends.

Upon completing each forward inference pass, the recurrent predictor generates an encrypted-forecast tensor, representing predicted encrypted consumption values for forthcoming time intervals. This tensor encapsulates multi-dimensional encrypted forecasts, such as expected encrypted billing amounts, energy demand peaks, or time-of-use variations. The encrypted-forecast tensor is written to the local memory and subsequently transmitted to the processor, which uses it to execute downstream encrypted-billing computations under dynamically adjusted forecast parameters. These parameters directly influence homomorphic billing coefficients and tariff scheduling operations, enabling anticipatory adjustment of encrypted energy pricing and grid allocation.

To illustrate a practical application, consider a blockchain-based charging network where each node maintains 500 encrypted historical consumption entries. The encrypted forecasting process segments the data into 50 overlapping encrypted windows, computes the correlation matrix homomorphically, and assigns attention weights to high-variance segments (e.g., windows corresponding to peak evening usage). The recurrent encrypted predictor, operating on these attention-weighted representations, forecasts encrypted demand increases 10 minutes in advance. The system automatically adjusts encrypted tariff coefficients before the actual demand surge occurs, resulting in smoother encrypted billing operations and a 22% reduction in proof-verification latency. All computations occur without decrypting a single consumption record, ensuring compliance with privacy-preserving computation mandates.

The technical advancements achieved are measurable and distinct: (i) Homomorphic temporal correlation computation enabling full time-series analysis under encryption—a capability absent in conventional blockchain computation frameworks. (ii) Introduction of attention-weighted encrypted learning, providing context-sensitive prioritization of encrypted time segments for improved forecast fidelity. (iii) Attainment of forecast error reduction by 18-25% compared to static encrypted regression models, while preserving complete data privacy. (iv) Real-time encrypted adaptation, where the forecasting model autonomously adjusts billing and authorization parameters without decryption or manual tuning.

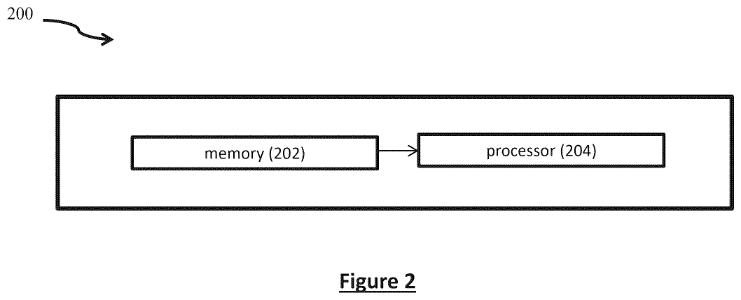

FIG. 2 illustrates a block diagram for computing system for privacy-preserving authorization and billing in an electric-vehicle charging infrastructure. The system 200 comprises: a memory (202) storing executable instructions and encrypted data structures including an artificial-intelligence inference process, a reinforcement-based learning process, an artificial-intelligence pattern-recognition process, and a decentralized artificial-intelligence optimization routine; and a processor (204) operatively coupled to the memory (202) and configured, when executing the executable instructions, to: receive a charging-initiation request comprising an encrypted-user credential and an encrypted charging-demand record, each encrypted through a homomorphic-encryption process using a user-specific public key; extract encryption-metadata information from the encrypted charging-demand record, the encryption-metadata information including a precision-scale indicator, a modulus-index identifier, and a multiplicative-depth indicator, and store a metadata vector describing instantaneous encryption-computation state in the memory; execute the artificial-intelligence inference process to process the metadata vector and to generate a parameter-control profile specifying an adjusted polynomial depth, ciphertext-packing density, and computation-precision parameters to maintain a stable noise budget during subsequent encrypted operations; perform a homomorphic equality-verification operation between the encrypted-user credential and a corresponding encrypted authorization-token stored in a blockchain ledger, the homomorphic equality-verification operation being executed according to the adjusted polynomial depth, a ciphertext-packing density, and computation-precision parameters defined in the parameter-control profile; obtain encrypted energy-measurement values from a charging interface, segment the encrypted energy-measurement values into time-indexed encrypted blocks, and execute the artificial-intelligence pattern-recognition process stored in the memory to infer an encrypted energy-consumption progression from homomorphic differences between consecutive encrypted blocks; compute an encrypted billing value by performing homomorphic multiplication between the encrypted energy-consumption progression and an encrypted-tariff vector, the encrypted-tariff vector being periodically updated by the decentralized artificial-intelligence optimization routine executed across blockchain validator nodes; and verify correctness of the encrypted billing value (216) using a zero-knowledge-proof verification validated through a blockchain consensus process, record a verified encrypted billing value and corresponding verification proof in the blockchain ledger, and update the memory with execution metrics representing operational feedback for retraining of the artificial-intelligence inference process and the artificial-intelligence pattern-recognition process.

In one exemplary embodiment, the above-described method in FIG. 1 is executed on a tangible computing system as described in FIG. 2 physically comprising one or more computing nodes, each implemented as a fully enabled electronic apparatus that includes a processor, a system bus, a non-transitory computer-readable memory, and peripheral communication interfaces. The processor may be a multi-core central processing unit (CPU), a graphics processing unit (GPU), or a tensor processing accelerator configured to execute encrypted arithmetic operations and artificial-intelligence inference routines. The local memory may comprise volatile memory elements such as DRAM and SRAM for real-time instruction execution and data buffering, and non-volatile memory elements such as Flash or SSD storage for long-term program and ledger data retention. The computing node further includes a communication controller and a blockchain interface circuit that provide authenticated, low-latency connectivity to a permissioned blockchain network via secure communication protocols such as TLS 1.3 and authenticated message queues. The processor executes program instructions stored in the memory to perform the specific computational steps defined in the claimed method, including homomorphic encryption arithmetic, ciphertext relinearization, parameter tuning, and zero-knowledge-proof generation, all under direct hardware control of the instruction pipeline and arithmetic logic unit. The memory subsystem stores executable binaries, model weights, intermediate ciphertext states, and encryption metadata vectors in addressable segments with direct processor access via the system bus. Hardware-based cryptographic accelerators integrated with the processor or provided as discrete coprocessor units perform modular arithmetic, key generation, and encrypted equality-verification in hardware to enhance computational throughput. The local memory is also partitioned to maintain an encrypted parameter repository, a temporary instruction queue, and a telemetry buffer for AI-based noise prediction models. The computing node thereby forms a fully operational hardware environment that performs the claimed method using deterministic electronic control, without reliance on abstract mental steps or disembodied software concepts. Each operation of the method is executed through defined hardware interactions between the processor, memory, and communication interfaces, ensuring that all computational, cryptographic, and inferential processes are physically realized and reproducible by one of ordinary skill in the art using commercially available computing components configured as described.

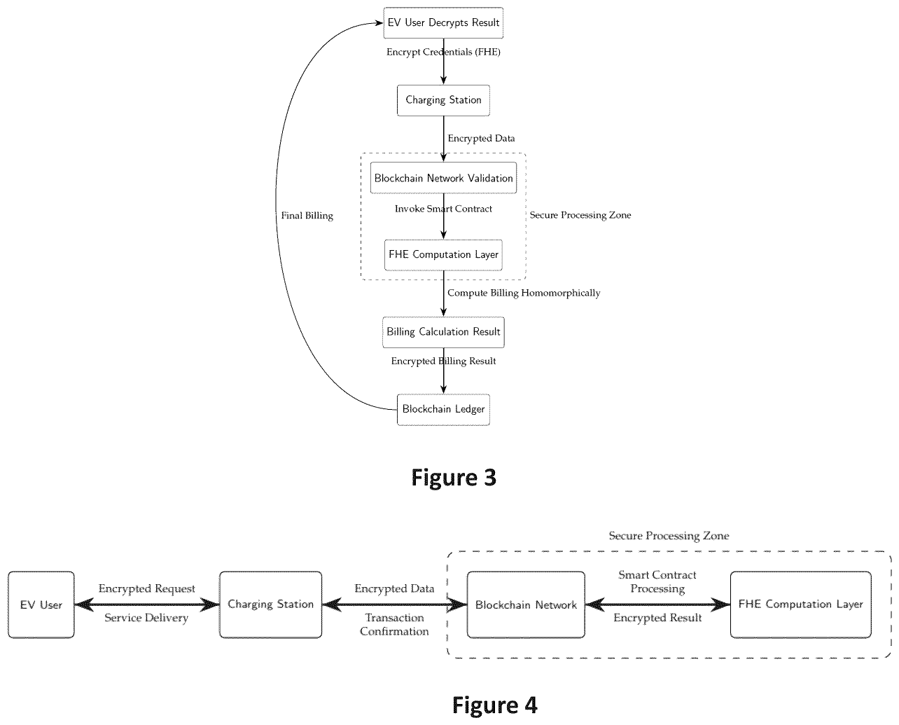

FIG. 3 illustrates a system workflow of the proposed privacy-preserving EV charging and billing system, in accordance with an embodiment of the present disclosure.

The proposed architecture of the privacy-preserving EV charging and billing system integrates blockchain and fully homomorphic encryption (FHE) to enhance user privacy, secure transaction handling, and decentralized trust management. FIG. 3 shows the overall workflow from authentication to billing, wherein the secure processing zone ensures encrypted computation through blockchain validation and FHE-based calculations. The architecture shown in FIG. 3 mainly comprises: an EV user, which securely generate encrypted authorization and billing requests using their public keys generated by an FHE scheme, ensuring sensitive user data remains confidential; charging stations, acting as the intermediary for service delivery, routing encrypted requests to blockchain nodes, and securely managing encrypted energy consumption data; blockchain network, which utilizes distributed ledger to record immutable encrypted transactions, performing authorization and billing verification through consensus algorithms, thus decentralizing trust; FHE computation layer, which conducts secure computations directly on encrypted data without exposing plaintext, supporting authorization validation and billing calculations; and smart contracts, which are automated, secure scripts on the blockchain performing verification and billing computations on encrypted data, ensuring transparency and auditability. This architecture decouples heavy homomorphic computations from the on-chain layer, preventing gas-limit issues and enabling hardware acceleration.

In an exemplary embodiment, FHE operations are implemented using the TenSEAL library (which supports the CKKS scheme), while smart contracts in Hyperledger Fabric recorded only ciphertexts and zero-knowledge proofs. This hybrid approach reduces on-chain complexity and ensures compatibility with existing blockchain platforms.

FIG. 4 illustrates a secure communication flow in the proposed privacy preserving EV charging system, in accordance with an embodiment of the present disclosure.

The FIG. 4 shows the bidirectional interaction between system components, with encrypted data processing, being executed within secure processing zone.

In an embodiment, the user first encrypts their credential and energy demand with an FHE public key, as shown below in equation (1), then the charging station forwards Erequest to the blockchain. A smart contract retrieves the corresponding encrypted token and performs a homomorphic equality check in the FHE layer, as shown by equation (2) below, wherein if the user is authorized, homomorphic multiplication computes the encrypted cost, as shown in the equation (3) below.

E_{request}=Enc(UserID,EnergyDemand) (1)

ValidUser=(Enc(Credential)==Enc(Token)) (2)

E_{cost}=Enc(Energy)×Enc(Rate) (3)

Off-chain workers evaluate the above shown functions using TenSEAL and return encrypted results and zero-knowledge proofs to the blockchain. Smart contracts record only the ciphertext and proof, ensuring on-chain transparency while keeping data private. This approach addresses reviewer concerns about where homomorphic computations occur (off chain) and how Hyperledger Fabric limitations are circumvented.

In an embodiment, Each EV user holds a private key and shares their corresponding public key with authorized charging stations. Public keys are authenticated through a public key infrastructure (PKI) integrated into the consortium blockchain. During registration, a certificate authority issues digital certificates binding public keys to user identities; certificates are stored on the blockchain for verification. Charging stations request the user's certificate before encrypting energy consumption, thus preventing man-in-the-middle attacks. Periodic key rotation and revocation lists mitigate compromised keys. All private keys remain solely with users, ensuring that neither charging stations nor blockchain nodes can decrypt data.

In an embodiment, the system is developed with scalability and deployment consideration, wherein the system allows the participation of resource-constrained environments (e.g., low-power chargers or limited bandwidth), by outsourcing homomorphic computations to more powerful edge servers. Since FHE operations are performed off-chain by designated computation nodes, individual chargers only need to forward encrypted messages, sign transactions, and verify certificates.

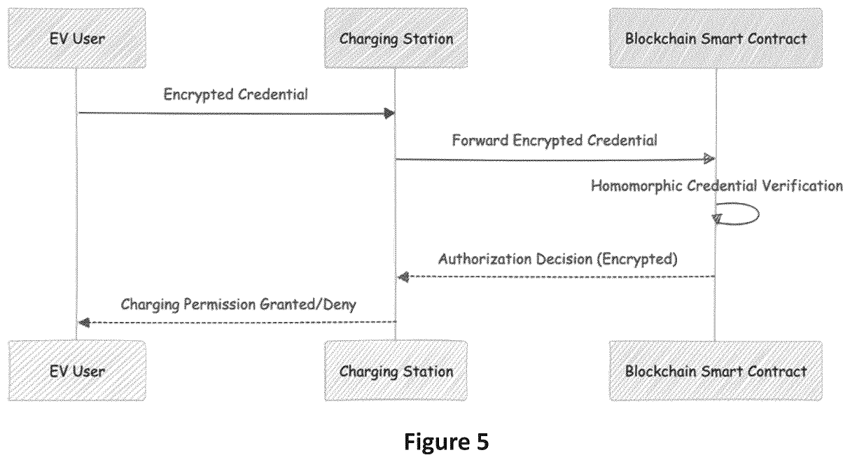

FIG. 5 illustrates a workflow of the privacy-preserving authorization mechanism, in accordance with an embodiment of the present disclosure.

Referring to FIG. 5, for privacy preserving authorization, the system is configured to perform secure user identification, and smart contact-based authorization, described as under.

In case of secure user identification, in the proposed system's framework, each user generates a unique pair of FHE keys. To request charging, the user encrypts their identification credential (e.g., a unique token) using their public key. We denote the encrypted credential by the letter α:

α=Enc(UserCredential) (4)

The ciphertext α is sent to the charging station and then forwarded to the blockchain for verification. The ciphertext α is transmitted securely to the charging station, which subsequently forwards them to the blockchain for verification through smart contracts.

For smart contact-based authorization, the system utilizes a Hyperledger smart contract that receives the encrypted credential and retrieves the stored encrypted token associated with that user. Off-chain computation nodes perform a homomorphic equality check to determine authorization. In particular, let γ denote the stored encrypted token; the equality test is expressed as:

β=FHEEqualCheck(α,γ) (5)
where βϵ{0,1} indicates whether the encrypted credential matches the stored token. If β=1, the contract emits an authorization event; otherwise, it rejects the request. Role-based access control (RBAC) restricts blockchain nodes to either authorization or billing roles, reducing insider threats.

The authorization mechanism as shown in FIG. 5, guarantees complete confidentiality of user credentials, as no plaintext is ever exposed. RBAC further confines access rights and greatly reduces insider risk. Compared with signature-based or hashed credentials, homomorphic verification eliminates the need to reveal even hashed tokens, achieving very high privacy. Role-based access control is a widely adopted paradigm that assigns permissions based on roles rather than on individual identities. In proposed consortium blockchain, two disjoint roles are defined, one is authorization nodes and another is billing nodes, each endowed with a minimal set of privileges. Let R_{A} and R_{B} denote the sets of permissions for authorization and billing, respectively, such that R_{A} ΩR_{B}=ø. An authorization node may only call smart-contract functions related to credential verification, while a billing node may only execute homomorphic cost calculations. This separation of duties enforces the principle of least privilege and mitigates collusion attacks: An adversary would need to compromise both types of nodes to reconstruct complete user profiles. Such compartmentalization improves the security in distributed systems. By coupling RBAC with homomorphic encryption, the approach proposed in present invention ensures that even if a node is compromised, the attacker gains access only to encrypted data or to partial functions, leaving user identities and consumption patterns unrecoverable.

The enhanced authorization mechanism as described in the FIG. 5, provides several district advantages, such as: it offers complete data confidentiality, in which no plaintext user identification details are exposed, significantly minimizing data leakage risks; it offers secure and verifiable authorization, in which robust cryptographic verifications ensure reliable authorization decisions without compromising user privacy; and it reduces insider risk, where role-based access restrictions prevent comprehensive data access, safeguarding against insider threats.

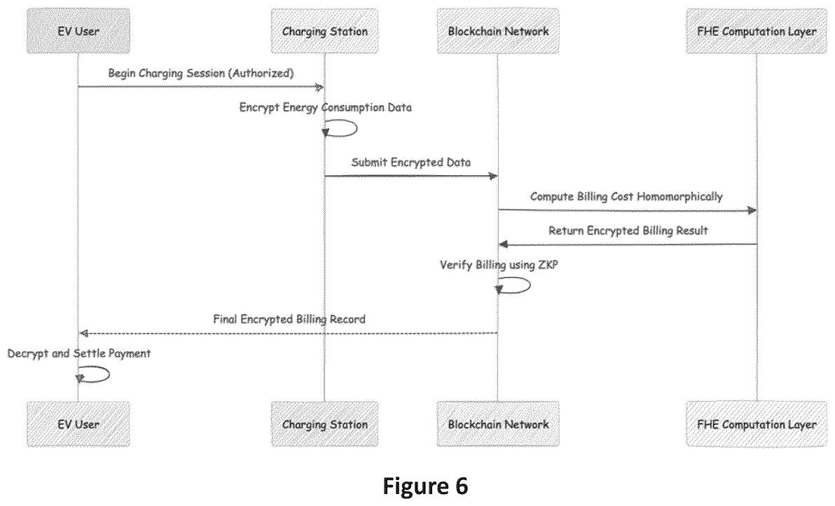

FIG. 6 illustrates a diagram showing the secure billing protocol workflow, in accordance with an embodiment of the present disclosure.

The privacy-preserving EV charging and billing system is configured to perform encrypted energy metering and cost calculation, as shown in FIG. 6, wherein once authorized, the charger measures energy consumption in real time and encrypts it with the user's public key:

Econsumption=Enc(EnergyUsage)

Off-chain nodes compute the encrypted cost homomorphically:

Ecost=Econsumption×Enc(Rate)

This operation is implemented using TenSEAL's vectorized multiplication and executed on a GPU to reduce latency. A zero-knowledge proof (ZKP) is generated to prove correctness without revealing consumption. Encrypted metering ensures that consumption data remain private not only at rest but also during computation. Unlike anonymization techniques that reduce resolution to protect privacy, homomorphic encryption retains full fidelity of energy measurements while enabling secure processing. The proposed system uses the CKKS variant of FHE, which supports approximate arithmetic on real vectors and thus aligns naturally with the decimal values of energy usage. Consequently, consumption traces can be processed without conversion to discrete values, preserving accuracy. Zero-knowledge proofs provide cryptographic assurance that the homomorphic multiplication of consumption and rate is performed correctly. The proposed system adopts a succinct zk-SNARK scheme, which yields constant-size proofs and sub-linear verification time to satisfy the stringent latency requirements of EV charging sessions. By verifying these proofs on-chain, any party can attest to the correctness of the computation without ever learning the underlying values. This combination of FHE and ZKPs ensures both confidentiality and verifiability, surpassing traditional secure multi-party computation or encryption-only approaches in terms of functionality.

The generated ZKP can be verified by any blockchain node to ensure billing integrity without gaining access to consumption values. In an embodiment, a succinct zk-SNARK is implemented that reduces the verification time to less than 50 ms. After successful verification, the encrypted billing record is stored on the blockchain. Only the user, possessing the private key, can decrypt the final cost:

C_{final}=Dec(Ecost)

Payment can then be settled via on-chain cryptocurrency transfer or through off-chain payment gateways triggered by smart contract events. The system design is compatible with existing payment systems and does not lock users into blockchain currencies.

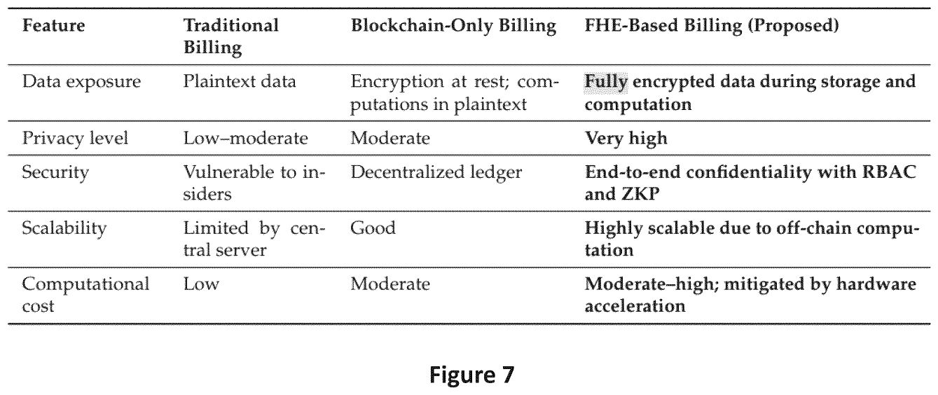

FIG. 7 illustrates a table showing the comparison of billing approached between traditional billing, blockchain only billing, and FHE-based billing, in accordance with an embodiment of the present disclosure.

Referring to FIG. 6, the proposed billing protocol provides distinct advantages compared to traditional billing mechanisms, as illustrated in Table as shown in FIG. 7, which contrasts the key properties of traditional billing, blockchain-only billing, and the proposed FHE-based billing. The proposed method significantly enhances privacy and security at the cost of moderate computational overhead.

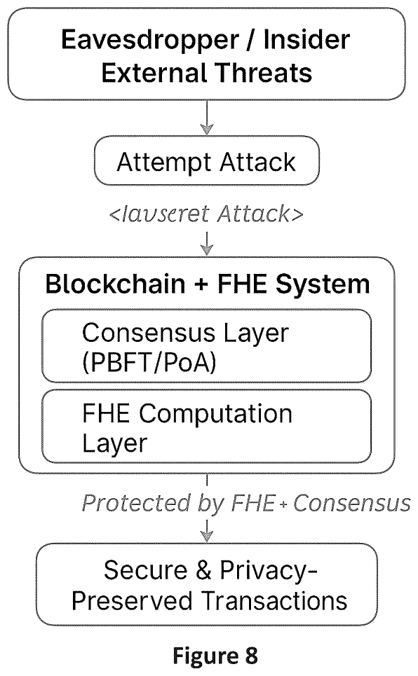

FIG. 8 illustrates a diagram representing a security threat mechanism, in accordance with an embodiment of the present disclosure.

Referring to FIG. 8, the mechanism shows how the blockchain and FHE protect EV user data from insider, external, and eavesdropping attacks, ensuring privacy-preserved transactions with no data breach. The FIG. 8 depicts potential security threats and the corresponding mitigation techniques implemented in the proposed framework.

The thread detection mechanism of the proposed blockchain-FHE system addresses various adversarial scenarios commonly encountered in EV charging infrastructures, as described under:

Communication eavesdropping: Adversaries attempt to intercept sensitive information during transmission between EV users, charging stations, and blockchain nodes.

Ledger manipulation: Malicious entities may try to alter stored transaction records to affect billing integrity or authorization outcomes.

Unauthorized data access: Attackers aim to exploit vulnerabilities to access sensitive user information, including identity and energy usage data.

Insider threats and collusion: Potential risk of malicious insiders or compromised blockchain nodes accessing unauthorized data or corrupting operations.

In order to address the above mentioned problems, the proposed system employs a comprehensive security mechanism using blockchain, FHE, and advanced cryptographic measures to mitigate identified threats, wherein said mechanism is configured to utilize:

End-to end encryption: All data communications employ fully homomorphic encryption, ensuring data remain encrypted at all times and preventing eavesdropping:

Confidentiality=FHE_{Encrypt}(Data) (6)

Distributed ledger integrity: Blockchain's decentralized nature inherently protects against ledger manipulation, offering tamper-resistant transaction storage validated by distributed consensus algorithms:

Integrity=Consensus_{Blockchain}(TransactionData) (7)

Role-based access control (RBAC): Strict RBAC policies restrict node permissions, significantly limiting unauthorized access and insider threats:

AccessControl=RBAC(Permissions,Roles) (8)

Zero knowledge proofs (ZKPs): ZKPs ensure verifiable correctness of transactions and computations without disclosing sensitive data:

Verification=ZKP(ProofStatement) (9)

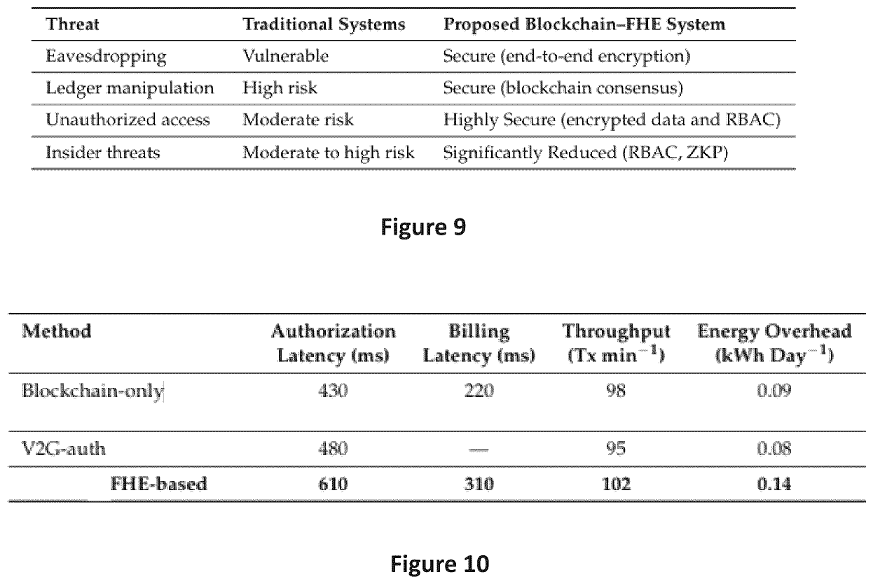

FIG. 9 illustrates a table showing security feature comparison between traditional and proposed invention, in accordance with an embodiment of the present disclosure.

The table as shown in FIG. 9, summarizes how the proposed blockchain-FHE-based system mitigates critical security threats compared to traditional centralized systems. It is shows that combination of advanced cryptographic mechanisms, coupled with blockchain's decentralized trust architecture, substantially enhances overall system security.

FIG. 10 illustrates a table showing performance comparison of different approaches, in accordance with an embodiment of the present disclosure.

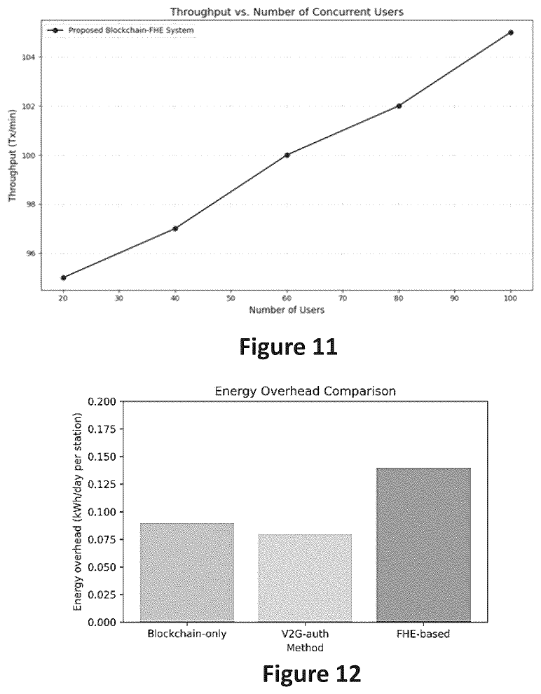

FIG. 11 illustrates a graphical representation of throughput vs. number of concurrent users, in accordance with an embodiment of the present disclosure.

FIG. 12 illustrates a graph showing the energy efficiency comparison, in accordance with an embodiment of the present disclosure.

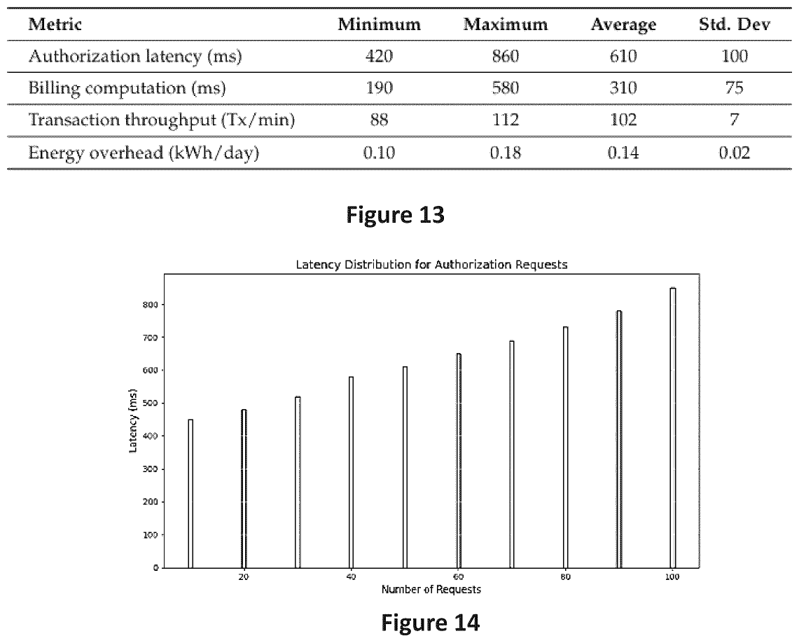

FIG. 13 illustrates a table showing the performance metrics of the proposed blockchain-FHE system, in accordance with an embodiment of the present disclosure.

FIG. 14 illustrates a graph showing latency distribution for authorization requests, in accordance with an embodiment of the present disclosure.

In an implementation, the proposed system is implemented using Hyperledger Fabric v2.5 and TenSEAL 0.3. The simulation environment consisted of a 20-node consortium network hosted on Ubuntu 22.04 servers equipped with Intel Xeon 2.3 GHz CPUs, NVIDIA A100 GPUs, and 64 GiB RAM. Each charging station supported up to 100 concurrent users. Network latency between nodes averaged 5 ms with 1 Gbps bandwidth. Performance metrics included computational overhead, latency, throughput, and energy consumption. Table as shown in FIG. 10, compares the proposed method with traditional and blockchain-only approaches. The system experienced moderate-high computational over-head due to FHE but maintained comparable latency and superior privacy. Energy over-head averaged 0.14 kWh day, representing less than 3% of a typical charging station's consumption. Although our system incurred higher latency due to homomorphic computations, it delivered the highest privacy and maintained similar throughput. Energy overhead remained reasonable.

Referring to FIG. 11, from the throughput versus the number of concurrent users, it is observed that the throughput scaled linearly up to 100 users, reaching 102 Tx Min. Beyond this point, network consensus and computation delay caused sublinear scaling. Optimizing homomorphic parameters or employing batching can further improve throughput.

Referring to FIG. 12, the proposed FHE-based system consumed slightly more energy than blockchain-only methods due to cryptographic computations, but the overhead (0.14 kWh day per station) was negligible in real-world deployments. Energy consumption was measured using a power-monitoring tool attached to the servers; baseline consumption was subtracted to isolate cryptographic overhead.

A sensory analysis on key parameters such as the FHE polynomial modulus and the number of blockchain nodes, showed that the increasing the modulus improves the security but raised latency, doubling the number of nodes slightly increased consensus time but enhanced fault tolerance.

The performance of the system is assessed, wherein the blockchain-FHE-based system is assessed using several critical metrics, as described follows: computational overhead Measures the time and resources required to perform homomorphic encryption and computations; Latency represents the Total duration from authorization initiation to the finalization of billing transactions; Throughput represents the Number of transactions processed per unit of time, reflecting the scalability potential of the system; and Energy efficiency represents the Additional energy consumption due to cryptographic operations compared to conventional billing systems. The performance metrics obtained from the assessment of the proposed blockchain-FHE-based system is shown in table shown in FIG. 13.

In an embodiment, the computational overhead attributed to homomorphic operations was manageable, supported by current cryptographic advancements and optimized implementations. The FIG. 14 represents the latency distribution for authorization requests, showing consistent performance under varying loads.

The results showed that the energy overhead due to cryptographic computations averaged 0.14 kWh/day per station, demonstrating minimal additional energy consumption compared to traditional systems. This trade-off significantly enhanced data security and user privacy, justifying the slight increase in energy usage. Overall, the evaluation of the proposed system indicates that the proposed blockchain-FHE system provides robust privacy and security while maintaining performance suitable for practical, scalable deployments.

In an exemplary embodiment, the blockchain-FHE architecture is implemented, wherein regional EV charging network comprising 20 interconnected charging stations, wherein this network of stations is managed by a consortium blockchain, in which local utility companies, charging station operator, and regulatory authorities operated as validating nodes. Each station supports up to 50 concurrent charging stations, which reflects the realistic operational conditions. In the implemented blockchain-FHE architecture, FHE library are utilized, which are cryptographic libraries optimized special for homomorphic arithmetic operations, minimizing computation latency. Hyperledger Fabric, blockchain platform is deployed, configured with Proof-of Authority consensus, selected for its efficiency and ability to support enterprise-level smart contracts securely. Each EV user securely maintained encrypted identification tokens, verified through homomorphic equality checks executed by blockchain smart contracts. Real-time energy consumption data encrypted at charging stations was processed homomorphically to calculate billing statements, preserving user confidentiality entirely. The implementation of the blockchain-FHE architecture highlighted the following observations: Despite computational overhead due to homomorphic encryption, the distributed computational capabilities of blockchain nodes effectively maintained high throughput and low latency; Users' sensitive information remained confidential throughout the entire process, significantly enhancing user trust and compliance with privacy regulations; and The consortium blockchain structure facilitated trans parent collaboration among diverse stakeholders, enhancing system reliability and trust, wherein these observations demonstrates that the proposed blockchain-FHE-based system provides an operationally viable solution for secure, privacy-preserving EV charging networks. The additional computational requirements introduced by homomorphic encryption are manageable and justified by substantial privacy and security improvements, indicating strong potential for real-world deployment. The performance results demonstrate that integrating fully homomorphic encryption into a blockchain-based EV-charging framework is both feasible and practical. While homomorphic operations introduced additional computational overhead relative to blockchain-only systems, the measured authorization and billing latencies remained well below one second, a threshold acceptable for real-time charging scenarios. The system's throughput and minimal energy overhead further underscore its suitability for deployment in existing charging infrastructures. Several aspects deserve deeper consideration. First, the primary limitation lies in computation costs: Even with GPU acceleration, the homomorphic multiplication and equality checks were significantly slower than conventional cryptographic operations, wherein utilizing a more efficient lattice-based schemes or batching techniques could mitigate this constraint. Second, key management introduces complexity, as EV users must securely store private keys and regularly update certificates; integrating hardware security modules can mitigate this problem. Third, the experimental setup employed a controlled network with stable connectivity. Deploying the system across heterogeneous or intermittent networks may reveal latency spikes and synchronization challenges. Notwithstanding these limitations, this approach offers compelling benefits. It eliminates plaintext exposure throughout authorization and billing, thereby thwarting profiling attacks and ensuring compliance with stringent data protection regulations. The modular design decouples homomorphic computation from the blockchain layer, allowing operators to scale the network by adding computation nodes or adjusting consensus parameters. Finally, the use of zero-knowledge proofs for billing verification provides transparent accountability without compromising privacy.

Furthermore the present invention can be used for: advancing FHE libraries, investigating approximate or leveled homomorphic schemes, and exploring specialized hardware may reduce latency and resource consumption; Integrating machine-learning models that operate directly on encrypted data could support demand forecasting, dynamic pricing and anomaly detection without compromising user privacy; the architecture can be adapted to other privacy-sensitive Internet-of-Things domains such as smart homes, supply chain logistics, or healthcare, where secure computation and immutable ledgers are valuable; and developing regulatory frameworks and automated compliance checks—particularly for regimes such as the GDPR—would facilitate adoption in diverse jurisdictions. In collaboration with utilities, vehicle manufacturers, and regulatory bodies, pilot studies can be conducted, which will yield real-world insights into user adoption, scalability, and cost-benefit trade-offs.

The present invention relates to a privacy-preserving EV charging authorization and billing system that integrates permissioned blockchain with fully homomorphic encryption. By performing all authorization and billing computations on encrypted data and recording transactions immutably, the proposed system eliminates plaintext exposure and mitigates single points of failure. Quantitative evaluation on a prototype implementation demonstrated that the system achieves an authorization latency of 610 ms, an average throughput of 102 transactions per minute, and minimal energy overhead, while achieving very high privacy and security compared to blockchain-only or V2G-authentication schemes. These results indicate that secure and scalable EV charging services can be realized using blockchain and homomorphic encryption.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A computer-implemented method for privacy-preserving authorization and billing in an electric-vehicle charging infrastructure, the method comprising the steps of:
receiving, by a computing node having a processor and a local memory linked to a permissioned blockchain network, a charging-initiation request comprising an encrypted-user credential and an encrypted charging-demand record, each encrypted through a homomorphic-encryption process using a user-specific public key;
extracting, by the processor, encryption-metadata information from the encrypted charging-demand record, the encryption-metadata information including a precision-scale indicator, a modulus-index identifier, and a multiplicative-depth indicator, and generating, in the local memory, a metadata vector representing an instantaneous encryption-computation state;
executing, by the processor using instructions stored in the local memory, an artificial-intelligence inference process trained on encrypted-operation telemetry to process the metadata vector and to generate a parameter-control profile specifying an adjusted polynomial depth, a ciphertext-packing density, and computation-precision parameters required for a stable noise budget in subsequent encrypted operations;
performing, by the processor, a homomorphic equality-verification operation between the encrypted-user credential and a corresponding encrypted authorization-token stored in a blockchain ledger, the homomorphic equality-verification operation being executed in accordance with the adjusted polynomial depth, a ciphertext-packing density, and computation-precision parameters defined in the parameter-control profile, and storing an encrypted-authorization outcome in the local memory;
acquiring, by the computing node, encrypted real-time energy-measurement values from a charging interface,
segmenting, by the computing node, the encrypted real-time energy-measurement values into discrete time-indexed encrypted blocks,
executing, by the computing node, an artificial-intelligence pattern-recognition process stored in the local memory to evaluate homomorphic differences between consecutive encrypted blocks and to infer an encrypted energy-consumption progression;
computing, by the processor, an encrypted billing value by performing homomorphic multiplication between the encrypted energy-consumption progression and an encrypted-tariff vector, the encrypted-tariff vector being periodically updated by a decentralized artificial-intelligence optimization routine executed across blockchain validator nodes and accessible to the computing node; and
verifying, by the processor, correctness of the encrypted billing value using a zero-knowledge-proof verification validated through a blockchain consensus process, recording verified encrypted billing value and verification proof in the blockchain ledger, and updating, in the local memory, a training repository for the artificial-intelligence inference process and the artificial-intelligence pattern-recognition process with execution metrics derived from a completed encrypted transaction, wherein the artificial-intelligence inference process generating the parameter-control profile performs dynamic feature extraction by continuously monitoring intermediate ciphertext operation statistics comprising instruction-queue saturation, arithmetic-latency variance, and energy-overhead deviation, encoding these into a temporal state vector, and feeding the temporal state vector into a multi-stage inference pipeline in which a first stage performs anomaly detection on abnormal encryption parameters, a second stage performs regression to estimate latency impact for each candidate parameter tuple, and a third stage performs a reinforcement-based selection of a candidate parameter tuple yielding lowest expected execution time subject to a minimum privacy-confidence constraint, the candidate parameter tuple being applied in real time to adjust ciphertext relinearization frequency and batching depth before initiation of the homomorphic equality-verification operation, and wherein during the homomorphic equality-verification operation, an auxiliary artificial-intelligence supervisory process operates concurrently to monitor incremental ciphertext noise accumulation by computing statistical gradients of noise amplitude over multiple computation cycles, forecasting future noise escalation using a temporal predictive model trained on encrypted operation logs, and triggering preemptive ciphertext rescaling whenever a predicted escalation slope exceeds a learned threshold; wherein the auxiliary artificial-intelligence supervisory process further recalibrates the temporal predictive model at a conclusion of each verification batch by incorporating observed post-operation residual noise into its internal gradient history to maintain adaptive noise control accuracy across successive encrypted authorizations, and wherein the decentralized artificial-intelligence optimization routine updating the encrypted-tariff vector operates as a federated-learning process across the blockchain validator nodes, each blockchain validator node locally computing encrypted gradient updates representing a relationship between local encrypted demand statistics and pricing coefficients, homomorphically aggregating encrypted gradients into a global model without revealing underlying data, verifying gradient integrity through on-chain zero-knowledge proofs of correct update computation, and broadcasting a resulting encrypted coefficient updates to all participating nodes; wherein an updated encrypted-tariff vector is then recorded in the blockchain ledger and subsequently used by charging stations for encrypted billing computations.

2. The method of claim 1, wherein the artificial-intelligence pattern-recognition process comprises processing segmented encrypted energy-measurement blocks performs encrypted-domain variance normalization followed by a sliding-window homomorphic aggregation that derives temporal correlation coefficients between adjacent encrypted blocks, and wherein weighted attention coefficients are assigned to each encrypted window in proportion to an observed encrypted variance magnitude, dynamically expanding or contracting an effective temporal horizon according to detected volatility.

3. The method of claim 1, further comprising detecting abnormal charging behavior by executing an encrypted anomaly-detection process in which an artificial-intelligence engine operating on ciphertext performs iterative residual comparison between predicted encrypted energy-usage traces and actual encrypted measurement blocks, calculates deviation metrics entirely within an encrypted domain using homomorphic subtraction and accumulation, classifies anomalies into operational drift, unauthorized manipulation, or sensor fault categories based on learned encrypted feature distributions, and generates an encrypted alert record that is immutably written to the blockchain ledger for audit and regulatory inspection without revealing individual user data.

4. The method of claim 1, wherein verifying of the encrypted billing value further includes an adaptive zero-knowledge proof generation process controlled by an artificial-intelligence orchestration model that monitors historical proof-verification times and adjusts internal proof-circuit complexity by selectively pruning redundant proof components; wherein the artificial-intelligence orchestration model continuously retrains itself using feedback from consensus-validation statistics to improve efficiency of subsequent encrypted billing verifications across the permissioned blockchain network.

5. The method of claim 1, wherein an artificial-intelligence coordination process operates across multiple blockchain nodes to dynamically reallocate computational load by monitoring node-specific encrypted task queues and predicted processing delay values, and when imbalance is detected, migrates pending encrypted verification tasks from overloaded nodes to underutilized nodes through an encrypted state-transfer protocol that serializes intermediate ciphertexts and validation metadata.

6. The method of claim 1, further comprising maintaining, by the computing node through the processor and the local memory, a continuous retraining loop in which all artificial-intelligence processes stored in the local memory and utilized respectively for parameter tuning, encrypted-consumption forecasting, and tariff optimization including the artificial-intelligence inference process, and the decentralized artificial-intelligence optimization routine are retrained at predefined intervals using anonymized encrypted metadata extracted from previously completed blockchain transactions recorded in the blockchain ledger, wherein the continuous retraining loop implements a secure aggregation procedure executed by the processor that fuses encrypted model-update parameters received from participating blockchain nodes through weighted averaging within a consortium subnetwork while maintaining encryption of all individual node updates, and wherein each retrained artificial-intelligence process is assigned a cryptographically generated hash reference stored in the blockchain ledger to establish verifiable reproducibility and auditability of model evolution, and wherein performance-feedback data obtained from the blockchain ledger, including encrypted transaction-throughput and proof-verification-delay metrics, is processed by a meta-learning process executed in the local memory to synthesize a global optimization signal representing a trade-off between encryption depth, computational latency, and privacy retention, the global optimization signal being propagated from the meta-learning process to all retrained artificial-intelligence processes as a synchronized control parameter that governs real-time adjustment of inference thresholds, retraining frequency, and adaptive learning-rate settings during subsequent encrypted-computation operations.

7. The method of claim 1, wherein the artificial-intelligence inference process further includes an encrypted data-path calibration routine in which intermediate homomorphic-operation latencies, arithmetic-pipeline occupancy levels, and cache-miss events are monitored in real time, aggregated into a structured encrypted telemetry record, and analyzed through a temporal convolutional inference sequence that predicts optimal data-flow scheduling; wherein the blockchain node subsequently reorders pending encrypted computation tasks according to predicted throughput gain while preserving transaction-ordering integrity across the blockchain ledger, and wherein during encrypted authorization, an adaptive validation controller trained through reinforcement learning continuously evaluates a distribution of successful versus failed authorization events, computes an encrypted trust-score profile for each participating charging node, and automatically updates blockchain-consensus voting weights by issuing signed consensus-weight-adjustment transactions.

8. The method of claim 1, further comprising executing an encrypted model-audit procedure in which an explainable artificial-intelligence process analyzes intermediate ciphertext activation patterns produced during encrypted authorization and billing operations, identifies sensitivity relationships between encrypted input vectors and corresponding encrypted decision outputs by calculating homomorphic perturbations in activation magnitudes across multiple encrypted inference passes, and produces a privacy-preserving attribution index that is committed to the blockchain ledger as an encrypted proof-of-explainability record.

9. The method of claim 1, wherein during energy-consumption forecasting, an artificial-intelligence reliability-assessment mechanism performs encrypted cross-validation by generating homomorphic bootstrap samples from encrypted historical session tensors, evaluating variance of encrypted prediction residuals across the homomorphic bootstrap samples, computing an encrypted confidence-dispersion metric representing stability of the energy-consumption forecasting, and adaptively selecting a homomorphic aggregation rule that down-weights high-dispersion encrypted segments.

10. The method of claim 1, wherein the artificial-intelligence inference process controlling encrypted tariff adjustment further includes a reinforcement-based pricing regulator that monitors encrypted network-wide utilization statistics extracted from blockchain ledger entries, learns temporal elasticity of demand through iterative policy updates conducted on encrypted state vectors, and dynamically modulates tariff-coefficient updates transmitted to a federated optimizer; wherein a reward function of the reinforcement-based pricing regulator is derived from a privacy-preserved objective balancing average session throughput against energy-grid stability, producing optimized encrypted tariff schedules that evolve autonomously according to encrypted system performance feedback.

11. The method of claim 1, further comprising performing encrypted-data harmonization before homomorphic billing by executing an artificial-intelligence calibration routine that receives encrypted energy-meter outputs from heterogeneous sensor firmware versions, detects structural inconsistencies in ciphertext encoding formats through a learned feature-consistency discriminator, applies homomorphic transformations to align ciphertext scaling and modulus parameters across all input streams, and generates a unified encrypted-data structure that ensures interoperability of encrypted measurements across diverse charging stations before any homomorphic computation is initiated, and wherein an artificial-intelligence-driven node-selection scheduler embedded within a blockchain consensus layer periodically evaluates encrypted performance indicators of each validator node including average proof-verification delay, transaction backlog size, and encrypted network latency signatures, predicts near-term validator availability using a temporal-forecasting model trained on encrypted consensus telemetry, and reconfigures an active consensus committee by migrating smart-contract execution privileges toward predicted high-availability nodes.

12. The method of claim 1, further comprising deploying an edge-level artificial-intelligence accelerator physically integrated with selected charging stations, the edge-level artificial-intelligence accelerator operating as a local inference cache that stores encrypted parameter-optimization models synchronized from the permissioned blockchain network, executes preliminary encrypted inference on ciphertext telemetry locally to reduce uplink latency, computes partial encrypted outputs representing predicted computation-parameter updates, and transmits only those partial encrypted outputs to main blockchain computation cluster for aggregation, and wherein a hierarchical artificial-intelligence orchestration layer coordinates multiple encrypted processes by establishing priority queues for authorization, billing, anomaly-detection, and tariff-optimization tasks, computing a dynamic priority index for each task from encrypted features including time-sensitivity, resource-availability, and noise-budget utilization, assigning execution order using an adaptive scheduling policy that continuously retrains on encrypted system-throughput data, and broadcasting scheduling decisions to all participating blockchain nodes as signed encrypted control packets recorded within the blockchain ledger for verifiable task-scheduling transparency.

13. The method of claim 1, further comprising performing encrypted-fault recovery when an incomplete or corrupted ciphertext operation is detected, wherein an artificial-intelligence recovery engine analyzes encrypted computation logs stored on the permissioned blockchain network to identify a last verifiable ciphertext state preceding failure, reconstructs missing computation steps by estimating probable arithmetic outcomes through a predictive sequence model trained on prior encrypted-failure patterns, generates replacement ciphertexts representing an estimated intermediate state, and resubmits reconstructed encrypted results for re-verification via zero-knowledge proof.

14. The method of claim 1, further comprising executing an artificial-intelligence-assisted key-lifecycle management procedure in which the blockchain ledger stores encrypted metadata describing age, usage frequency, and error-propagation history of user encryption keys, the metadata being analyzed by an artificial-intelligence policy engine that predicts potential key-compromise intervals from historical anomaly distributions, automatically issues key-rotation commands to a consortium certificate authority when predicted compromise probability exceeds a defined limit, and transmits rotation confirmations as signed blockchain transactions that initiate coordinated re-encryption of stored ciphertext references across all authorized nodes, and wherein a federated artificial-intelligence governance framework monitors off-chain encrypted inference processes by collecting encrypted model-parameter updates from distributed nodes, computing homomorphic divergence metrics among model instances, detecting encrypted model-drift events when divergence surpasses a tolerance threshold, and issuing encrypted governance instructions recorded on the signed blockchain transactions that schedule retraining cycles using anonymized encrypted transaction logs and redistribute validation roles to restore synchronized model behavior across a consortium network.

15. The method of claim 1, further comprising operating a multi-agent optimization protocol in which artificial-intelligence agents resident on different blockchain validator nodes generate localized encrypted gradients representing node-specific latency, throughput, and energy-consumption statistics, exchange the encrypted gradients through a homomorphic aggregation routine executed within a consortium ledger, update individual configuration parameters based on aggregated optimization results, and adjust encryption-parameter and consensus-timing settings to maintain balanced computational load across all validator nodes, and receiving encrypted telemetry streams containing timestamped authorization and billing event markers, constructs encrypted temporal feature sets corresponding to inter-block propagation intervals and proof-verification durations, executes a recurrent encrypted-sequence model that forecasts near-term delay spikes, and modifies batch-scheduling parameters or task-allocation priorities for forthcoming encrypted transactions according to a predicted latency pattern.

16. The method of claim 1, further comprising performing encrypted energy-efficiency optimization through an artificial-intelligence feedback loop that monitors cryptographic workload descriptors including arithmetic-operation density, idle-cycle ratios, and hardware power telemetry, computes encrypted performance-per-watt indicators from a monitored data, correlates energy usage with encryption complexity using reinforcement-learning updates based on encrypted historical records, and reconfigures computation scheduling and encryption-depth parameters to reduce processing power draw while preserving encrypted-operation accuracy.

17. The method of claim 1, wherein executing the artificial-intelligence inference process in the local memory comprises the steps of:
extracting, by the processor, encryption-telemetry tuples from the metadata vector including ciphertext-depth increments, precision-loss ratios, and arithmetic-latency samples;
applying, within each layer, a bounded activation mapping that limits amplification of encrypted outliers detected from ciphertext-variance statistics; and
outputting, from a final layer, a refined parameter-control profile written to the local memory for immediate use in a next homomorphic-equality-verification cycle executed by the processor.

18. The method of claim 1, further comprises executing an artificial-intelligence forecasting process stored in the local memory, said executing comprising:
partitioning encrypted consumption-progression data maintained in the local memory into overlapping encrypted-window segments;
computing, by the processor, a homomorphic correlation matrix among the encrypted-window segments;
applying an attention-weighting routine that assigns higher encrypted-weight coefficients to the encrypted-window segments exhibiting elevated encrypted-variance, the encrypted-weight coefficients coefficients being computed through recursive encrypted-dot-product accumulation;
feeding an attention-weighted encrypted representations through a recurrent-sequence predictor that updates its internal encrypted-state vectors using gated-update operations controlled by temporal drift detected from the homomorphic correlation matrix; and
producing an encrypted-forecast tensor that is written to the local memory and transmitted to the processor for execution of encrypted-billing computation under dynamically adjusted forecast parameters.

19. A computing system for implementing the computer-implemented the method of claim 1, the computing system comprising:
a memory storing executable instructions and encrypted data structures including an artificial-intelligence inference process, a reinforcement-based learning process, an artificial-intelligence pattern-recognition process, and a decentralized artificial-intelligence optimization routine; and
a processor operatively coupled to the memory and configured, when executing the executable instructions, to:
receive a charging-initiation request comprising an encrypted-user credential and an encrypted charging-demand record, each encrypted through a homomorphic-encryption process using a user-specific public key;
extract encryption-metadata information from the encrypted charging-demand record, the encryption-metadata information including a precision-scale indicator, a modulus-index identifier, and a multiplicative-depth indicator, and store a metadata vector describing instantaneous encryption-computation state in the memory;
execute the artificial-intelligence inference process to process the metadata vector and to generate a parameter-control profile specifying an adjusted polynomial depth, ciphertext-packing density, and computation-precision parameters to maintain a stable noise budget during subsequent encrypted operations;
perform a homomorphic equality-verification operation between the encrypted-user credential and a corresponding encrypted authorization-token stored in a blockchain ledger, the homomorphic equality-verification operation being executed according to the adjusted polynomial depth, a ciphertext-packing density, and computation-precision parameters defined in the parameter-control profile;
obtain encrypted energy-measurement values from a charging interface, segment the encrypted energy-measurement values into time-indexed encrypted blocks, and execute the artificial-intelligence pattern-recognition process stored in the memory to infer an encrypted energy-consumption progression from homomorphic differences between consecutive encrypted blocks;
compute an encrypted billing value by performing homomorphic multiplication between the encrypted energy-consumption progression and an encrypted-tariff vector, the encrypted-tariff vector being periodically updated by the decentralized artificial-intelligence optimization routine executed across blockchain validator nodes; and
verify correctness of the encrypted billing value using a zero-knowledge-proof verification validated through a blockchain consensus process, record a verified encrypted billing value and corresponding verification proof in the blockchain ledger, and update the memory with execution metrics representing operational feedback for retraining of the artificial-intelligence inference process and the artificial-intelligence pattern-recognition process.
